(19) United States
(12) Patent Application Publication
(10) Pub. No.: US 2026/0222148 A1
(43) Pub. Date: Jul. 30, 2026

(54) SIDELINK POSITIONING REFERENCE SIGNALS

(71) Applicant: Apple Inc., Cupertino, CA (US)

(72) Inventors: Chunxuan Ye, San Diego, CA (US); Dawei Zhang, Saratoga, CA (US); Oghenekome Oteri, San Diego, CA (US); Weidong Yang, San Diego, CA (US); Wei Zeng, Saratoga, CA (US); Haitong Sun, Saratoga, CA (US); Hong He, San Jose, CA (US)

(21) Appl. No.: 18/730,875

(22) PCT Filed: Aug. 11, 2023
(86) PCT No.: PCT/US2023/030087

§ 371 Date: Jul. 22, 2024

(51) Int. Cl. H04L 5/00; H04W 72/25

(52) U.S. Cl. CPC H04L 5/0051; H04W 72/25

(57) ABSTRACT

Systems, methods, and devices are provided for transmitting and receiving sidelink positioning reference signals (SL-PRS). In one example, a user equipment (UE), includes a memory and a baseband processor. The baseband processor is configured to, when executing instructions stored in the memory, cause the UE to select a sidelink positioning reference signal (SL-PRS) resource from a configured or preconfigured dedicated resource pool. The dedicated resource pool includes candidate physical sidelink control channel (PSCCH) resources configured to carry single stage sidelink control information (SCI) and candidate SL-PRS resources, wherein the dedicated resource pool does not include candidate resources for physical sidelink shared channel (PSSCH) transmission. The baseband processor is configured to cause the UE to transmit the SL-PRS in the selected SL-PRS resource.

### BACKGROUND

The present disclosure relates generally to wireless communication and more specifically to techniques for performing sidelink or device-to-device communication in a radio network.

### BRIEF DESCRIPTION OF THE DRAWINGS

Some examples of circuits, apparatuses and/or methods will be described in the following by way of example only. In this context, reference will be made to the accompanying figures.

FIG. 1 is a diagram of an example downlink (DL) position reference signal (PRS), in accordance with various aspects described.

FIG. 2 is a diagram of an example sidelink shared resource pool, in accordance with various aspects described.

FIG. 3 illustrates an example slot configuration for a sidelink physical sidelink control channel/physical sidelink shared channel (PSCCH/PSSCH) slot, in accordance with various aspects described.

FIG. 4 illustrates sidelink communication being performed in mode 1 or mode 2, in accordance with various aspects described.

FIG. 5 illustrates an example sidelink shared resource pool, in accordance with various aspects described.

FIG. 6 illustrates an example sidelink dedicated resource pool, in accordance with various aspects described.

FIGS. 7A and 7B illustrate example SL-PRS resources and different SL-PRS resource indexing ordering conventions, in accordance with various aspects described.

FIG. 8 is a table indicating a value for k′ used in SL-PRS sequence mapping, in accordance with various aspects described.

FIGS. 9A,9B,9C,9D illustrate different example mappings between PSCCH and sidelink positioning reference signal (SL-PRs) resources, in accordance with various aspects described.

FIG. 10 is a flow diagram outlining an example method for transmitting SL-PRS, in accordance with various aspects described.

FIG. 11 is a message flow diagram outlining an SL-PRS transmission process, in accordance with various aspects disclosed.

FIG. 12 is a flow diagram outlining an example method for transmitting SL-PRS using resources from a dedicated resource pool, in accordance with various aspects described.

FIG. 13 is a flow diagram outlining an example method for transmitting SL-PRS based on an allocation from a network, in accordance with various aspects described.

FIG. 14 is a flow diagram outlining an example method for configuring transmission of SL-PRS using resources from a shared dedicated resource pool that is linked to a dedicated resource pool, in accordance with various aspects described.

FIG. 15 is a flow diagram outlining an example method for requesting SL-PRS from a UE with which a unicast link has not been established, in accordance with various aspects described.

FIG. 16 is a flow diagram outlining an example method for transmitting SL-PRS based on configuration from a higher layer, in accordance with various aspects described.

FIG. 17 is a flow diagram outlining an example method for determining SL-PRS transmit power based on sidelink pathloss, in accordance with various aspects described.

FIG. 18 is a flow diagram outlining an example method for transmitting an indication of a transmission time of an SL-PRS, in accordance with various aspects described.

FIG. 19 is a functional block diagram of a wireless communication network, in accordance with various aspects described.

FIG. 20 illustrates a simplified block diagram of a user equipment device, in accordance with various aspects described.

### DETAILED DESCRIPTION

The present disclosure is described with reference to the attached figures. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

In many instances, a mobile communication device, such as a user equipment (UE), performs actions based on the device's position. Obvious examples include navigation applications and internet searches that seek results based on proximity to the device. To assist UEs in determining their position, base stations and access points transmit positioning reference signals (PRS) that may be received and measured by a UE for use in determining the UE's position. In uplink (UL), UEs transmit sounding reference signals (SRS) that may be received and measured by a base station or access point. The base station or access point may transmit measurement values for the SRS to the UE or compute and transmit positioning assistance information based on measurements of the SRS.

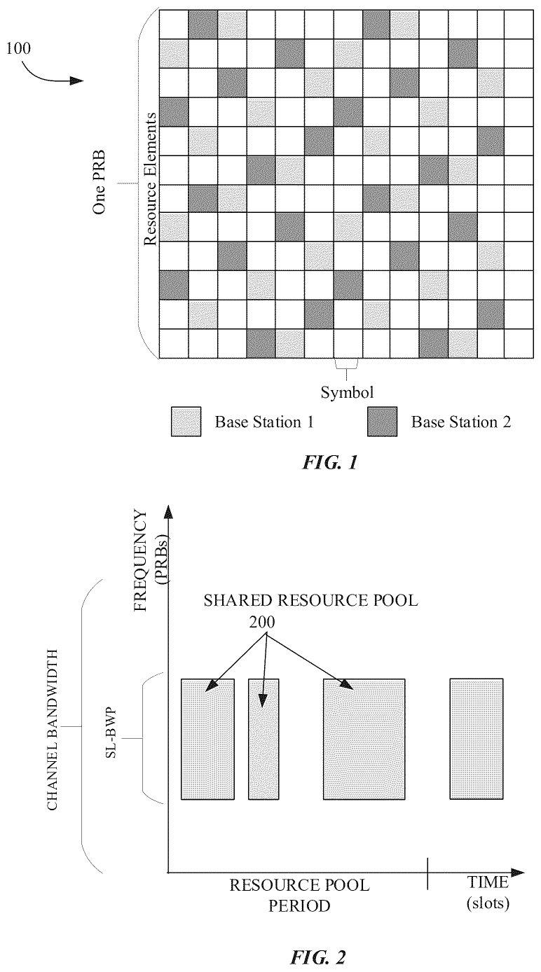

SRS and PRS are specifically designed to deliver high levels of accuracy, coverage, and interference avoidance and suppression. Individual SRS/PRS are small in terms of time and frequency resources (occupying a single subcarrier and a single symbol) and can be distributed across a whole communication bandwidth with repetition in multiple symbols so that the SRS/PRS may be aggregated to accumulate power. FIG. 1 illustrates an example PRS pattern 100 in which PRS from two base stations are multiplexed over a slot duration of twelve symbols throughout a physical resource block (PRB). The distribution of the PRS is configured by way of a comb size that defines a number N of symbols that can be combined to cover all subcarriers in the frequency domain and a comb offset that determines the position of the comb pattern. The PRS pattern 100 has a comb size of 6 and the PRS of the two different base stations have different comb offsets to prevent them from overlapping. SRS follow a similar comb-based configuration.

Various positioning methods are supported in 5G including angle of arrival (AOA), angle of departure (AOD), observed time difference of arrival (OTDOA), and round trip time (RTT). All of these methods rely on measurements of PRS/SRS or other positioning reference signals. Details of these methods are omitted herein for brevity.

Vehicle-to-everything (V2X) communication that supports features such as, platooning, pedestrian avoidance, and so on, relies on precise and accurate position information of devices that may be traveling at high speeds in crowded spaces and may also be out of coverage of a cellular network. It has been agreed that to support V2X, positioning methods that do not rely solely on signaling between a UE and a base station should be developed. Disclosed herein are techniques for supporting absolute or relative UE positioning based, at least in part, on sidelink PRS (SL-PRS). SL-PRS are positioning signals that are transmitted between a transmit (TX) UE and a receive (RX) UE instead of between a UE and a base station or access point.

Certain parameters associated with sidelink communication may be disclosed herein as being “(pre)-configured”. In NR, it is possible that a UE performing sidelink communication is not in the coverage of a network. In these circumstances, there may be no network configuration of sidelink communication parameters. When no network configuration has been made, both UEs may apply “pre-configured” parameter values. The pre-configured parameter values are “built-in” or programmed into a UE when it is manufactured. This pre-configured set of parameter values will remain the same for a UE and are used by the UE when there is no network coverage (or there is no configured parameter value from network). Thus, when a parameter value or other quantity associated with sidelink communication is described as being “(pre)-configured”, it means that the parameter value may be at some times a “pre-configured” value and at other times a network “configured” value.

### Sidelink Overview

### SL Shared Resource Pools

Certain slots are (pre-) configured to carry SL transmissions. Thus, the available sidelink resources include slots allocated for sidelink (time resources) and common resource blocks (RBs) within a sidelink bandwidth part (SL-BWP) (frequency resources). A subset of available SL resources is (pre-) configured to be used by several UEs for their SL transmissions. This subset of available SL resources is referred to as a “shared resource pool.”

An example shared resource pool for sidelink transmissions is illustrated in FIG. 2. The common resource blocks within a shared resource pool are referred to as PRBs. The shared resource pool 200 includes contiguous PRBs and contiguous or non-contiguous slots that have been (pre-) configured for SL transmission. The shared resource pool is defined within the configured SL-BWP and therefore a single numerology is used within a resource pool. The shared resource pool repeats in the time domain according to a resource pool period.

In the frequency domain, a shared resource pool is divided into a (pre-) configured number L of contiguous sub-channels, where a sub-channel includes a group of consecutive PRBs in a slot. The number Msub of PRBs in a sub-channel corresponds to the sub-channel size, which is (pre-) configured within a shared resource pool. A sub-channel represents the smallest unit for a sidelink data transmission or reception. In each slot of a shared resource pool, a subset of consecutive symbols are (pre-) configured for SL. The number of symbols allocated for SL may vary between 7 and 14 symbols. A shared resource pool (SRP) may be shared by several UEs for their SL transmissions. An SRP may be used for unicast, groupcast, and broadcast transmissions. A UE may be configured with multiple SRPs for transmission (transmit SRPs) and multiple SRPs for receiving (receive SRPs).

### SL Physical Channels

Sidelink communication occurs over four channels: a physical sidelink control channel (PSCCH), a physical sidelink shared channel (PSSCH), a physical sidelink broadcast channel (PSBCH), and a physical sidelink feedback channel (PSFCH). The PSBCH is primarily used for synchronization purposes and the PSFCH is used for carrying hybrid automatic repeat request (HARQ) feedback. PSCCH and PSSCH are used to transmit sidelink data.

Sidelink data is organized into transport blocks (TBs) and each TB is associated with sidelink control information (SCI). The SCI indicates the resources used by the PSSCH that carries the associated TB as well as further information used to decode the TB. Through Release-17, a PSCCH is always sent in a same slot with the associated PSSCH. The SCI is transmitted in two stages: a first stage that is carried in the PSCCH and a second stage that is carried in the associated PSSCH. Splitting the SCI into two stages allows UEs which are not the RX UE of the TB in a transmission to decode only the first stage SCI for channel sensing/resource selection purposes as will be described in more detail later.

The first stage SCI indicates the sub-channels of the PSSCH carrying the (re) transmission of the TB, as well as a resource reservation for up to two further retransmissions of the TB. The first stage SCI also indicates a resource reservation period in case of a semi-persistent resource reservation, a priority of the associated TB/PSSCH, and a format and size of the second stage SCI. The second stage SCI indicates a PHY layer source identifier (ID) of the TX UE and a PHY layer destination ID of the RX UE as well additional information used for decoding.

### SL Slot Structure

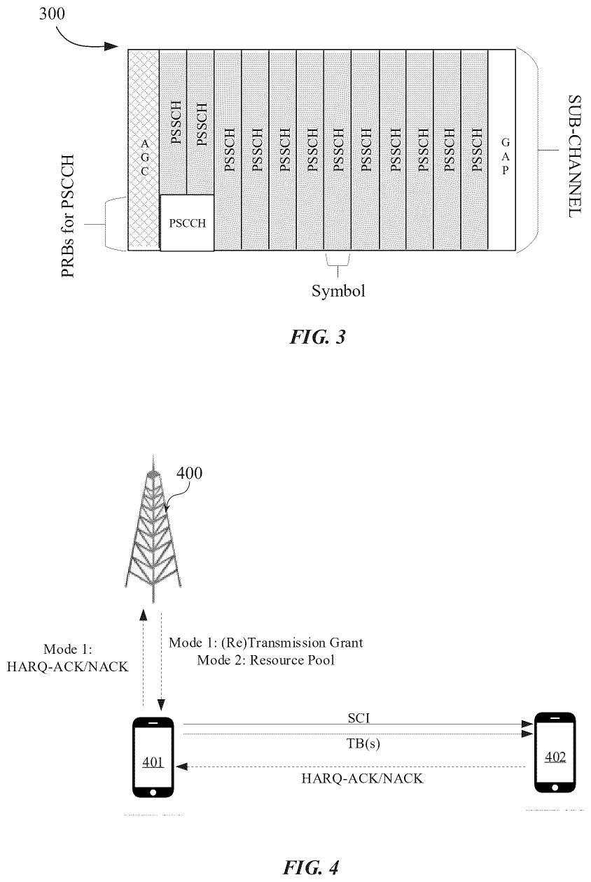

An example slot structure 300 is illustrated in FIG. 3. The PSCCH is multiplexed in non-overlapping resources with the associated PSSCH in the same slot. The PSCCH is transmitted from the second SL symbol in the slot and starting from the lowest PRB within the sub-channel(s) occupied by the associated PSSCH. The number of symbols for the PSCCH is (pre-) configured by shared resource pool and can be 2 or 3 symbols. The size of the first stage SCI is fixed within a shared resource pool. With L sub-channels within a resource pool, there are L possible locations for a PSCCH in a slot, starting from the second SL symbol in a slot and from the lowest PRB in each sub-channel. This limits the PRBs that must be blindly decoded for PSCCH. Every PSCCH symbol contains PSCCH demodulation reference signals (DMRS).

According to some aspects, the PSSCH carries the second stage SCI and an SL data payload. In addition to the source and destination IDs, the second stage SCI also includes a new data indicator and indications of a HARQ process ID, a redundancy version, whether HARQ feedback is enabled, and an optional geographical zone ID. The second stage SCI is decoded using PSSCH DMRS. PSSCH can be transmitted from the second SL symbol up to the second to last SL symbol in a slot. In contrast to PSCCH, which is carried in a selected contiguous PRBs, PSSCH may be carried in any sub-channel of the SL-BWP.

### SL Resource Selection

Referring to FIG. 4, sidelink communication may be performed according to one of two modes. In mode 1 the network controls resource allocation and receives feedback (e.g., by way of signals transmitted or received by a base station or network node 400) for transport blocks (TBs) transmitted between TX UE 401 and RX UE 402. In some examples, resources for sidelink transmission are signaled to the TX UE 401 as transmission grants such as dynamic grants or configured grants. The TX UE 401 transmits SCI and TBs using the resources allocated by the network and, when feedback is enabled, receives hybrid automatic repeat request acknowledgment/non-acknowledgement (HARQ-ACK/NACK) from the RX UE 402 on PSFCH. The TX UE 401 reports the HARQ-ACK/NACK to the base station, and the feedback is used by the network to determine whether the TB was decoded by the RX UE 402. When the network determines that a TB was not decoded by the RX UE 402, the network transmits a retransmission grant to the TX UE 401 indicating resources to be used to retransmit the TB.

In mode 2, a UE is (pre-) configured with a pool of sidelink resources from which the TX UE 401 autonomously selects resources to transmit TBs to the RX UE 402 without requiring a specific allocation from the network. Mode 2 is well suited for SL communication performed between UEs in close proximity to one another and/or when one or more of the UEs is out of coverage of the network.

In mode 2, the TX UE uses a sensing based resource selection scheme to autonomously select resources for transmitting PSCCH/PSSCH. The TX UE begins with a shared resource pool received from the network or uses a (pre-) configured shared resource pool. During a sensing window, the TX UE decodes SCI transmitted by other UEs. During a (pre-) configured resource selection window, the TX UE excludes candidate resources that have been reserved by other UEs. The TX UE then senses remaining PSCCH resources in the shared resource pool and measures the reference signal receive power (RSRP) of the PSCCH or PSSCH. The RSRP measurement may be made on DMRS carried by PSCCH symbols. The TX UE excludes candidate resources from the shared resource pool if the average RSRP for the candidate resource exceeds a (pre-) configured threshold. After this exclusion, the TX UE checks to see if the quantity of remaining available candidate resources is above a (pre-) configured percentage (e.g., 20%) of all candidate resources in the resource selection window. If there is not a sufficient quantity of remaining resources, the TX UE increases the threshold by a (pre-configured) step size and senses the PSCCH again during the selection window. Once a sufficient quantity of candidate resources remain in the resource pool, the TX UE randomly selects transmission resources. The TX UE transmits SCI reserving the resources so that the selected resources will be excluded from candidate resources of the shared resource pool in future resource selection by the TX UE or other UEs.

At a pre-emption time interval prior to transmitting using the selected resources, the TX UE performs a pre-emption check based on SCI transmitted by other UEs reserving resources. If the resources selected by the UE have been reserved for transmission of a higher priority PSSCH, the TX UE will refrain from transmitting PSCCH/PSSCH in the selected resources and performs the resource selection process again.

### SL Power Control

Power control for SL transmission of PSCCH, PSSCH, PSFCH, and PSBCH is open-loop. The transmit power of PSCCH is based on transmit power derived for the associated PSSCH. Broadcast and groupcast PSSCH transmission power is determined based on DL pathloss (between the TX UE and the base station). DL pathloss can be derived by the TX UE based on measurements of reference signals transmitted by a base station.

Unicast PSSCH transmission power may be (pre-) configured to be based on a downlink (DL) pathloss only, SL pathloss only, or both DL pathloss and SL pathloss. To determine SL pathloss, the TX UE receives, via sidelink RRC or PC5 RRC signaling from the RX UE, an average or filtered RSRP value for the TX UE's PSSCH DMRS based on several measurements. The TX UE uses this average RSRP value along with the transmit power of the measured PSSCH to determine the SL pathloss.

### SL-PRS for SL Positioning

Some of the unique characteristics of sidelink communication present challenges in the design of SL-PRS. For example, a UE may be requested to transmit SL-PRS to an RX UE when the UE does not have SL data to transmit to the RX UE, meaning that existing sidelink slot structures that include PSCCH and PSSCH in every slot may not be reused for transmission of SL-PRS. A dedicated resource pool that is tailored to transmissions of PSCCH and SL-PRS may be preferred over re-using the shared resource pool that supports PSCCH/PSSCH transmission, however, a dedicated resource pool presents additional design issues as will be disclosed below. Other SL-PRS considerations include mode 1/mode 2 resource allocation of for SL-PRS, power control, and timing considerations. Disclosed herein are SL-PRS solutions that address many of these issues.

SL-PRS are defined with respect to, and are contained within, a single SL bandwidth part (BWP) in a carrier. However, future implementations may support SL-PRS resource sets that span multiple SL BWP. SL-PRS are transmitted in time-frequency resources within a slot that is (pre-) configured for SL transmission. A configuration of an SL-PRS resource within a slot includes an SL-PRS resource ID which is a time domain indication of an SL slot, an SL-PRS comb offset and comb size (N), an SL-PRS starting symbol and a number of symbols (M), and an SL-PRS frequency domain allocation within an SL slot. In a shared resource pool, the SL-PRS frequency resource is identified by a combination of SL-PRS resource ID and SL-PRS frequency domain allocation. In a dedicated resource pool, an SL-PRS resource is identified by an SL-PRS resource index that refers to a combination of a time resource (e.g., symbol) and a frequency resource (e.g., resource element) within a configured SL-PRS slot.

### Shared SL-PRS Resource Pools and Dedicated SL-PRS Resource Pools

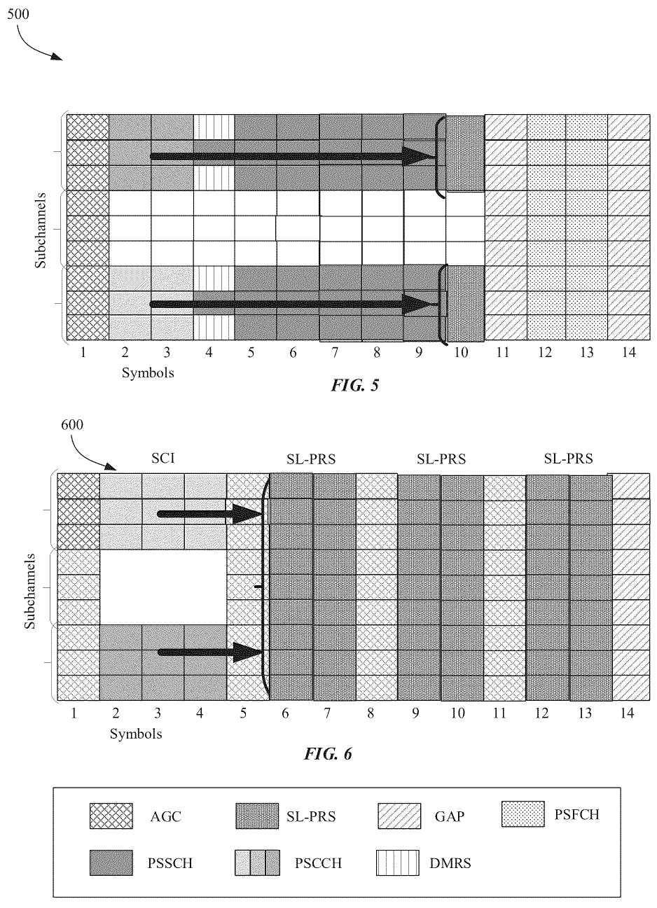

FIGS. 5 and 6 illustrate examples of a shared resource pool (hereinafter SL-PRS SRP) 500 and a dedicated resource pool 600 (hereinafter SL-PRS DRP), respectively, that may be used for sidelink positioning. A drawing key for the various SL signal types in the resource pools is provided below FIGS. 5 and 6. Either or both of SL-PRS-SRP(s) and SL-PRS-DRP(s) may be (pre-) configured for sidelink positioning.

The SL-PRS SRP 500 includes, in the same slot, resources for PSCCH and PSSCH. The SL-PRS SRP is divided into subchannels which may be used by different unicast pairs, groupcast, or for broadcast. It is noted that, in general, the PSCCH resources may occupy the whole SL subchannel and may occupy either two or three consecutive symbols, based on (pre-) configuration. First stage SCI (carried by PSCCH) and second stage SCI (carried by PSSCH) may be used to indicate SL-PRS. For SL-PRS comb sizes 1, 2, and 4 (see FIG. 1 for an illustration of a comb pattern), SL-PRS is time domain multiplexed (e.g., occurs in different symbols) with PSSCH and has a frequency bandwidth spanning the subchannel as shown in FIG. 5, with PSCCH in the top subchannel scheduling SL-PRS spanning the top subchannel and PSCCH in the bottom subchannel scheduling SL-PRS spanning the bottom subchannel. SL-PRS is carried in a number of consecutive symbols in the slot. A priority may be assigned to the SL-PRS and indicated in the associated SCI.

In contrast, the SL-PRS-DRP 600 does not include resources for PSSCH. The PSCCH subchannels are configured to carry single stage SCI that indicates one or more SL-PRS resources in a slot or multiple slots periodically or aperiodically as will be described in more detail. The frequency resources spanned by SL-PRS include the entire bandwidth of the SL-PRS-DRP, rather than a single subchannel as with the SL-PRS-SRS of FIG. 5.

The PRBs in the resource pool 600 are divided into multiple sub-channels and each sub-channel may be used by a different TX UE. FIG. 6 illustrates three different SCI sections, each carried in a sub-channel of the PSCCH. Each SCI section may carry a single stage SCI for a particular SL-PRS resource. The single stage SCI indicates a source ID and destination ID (e.g., a unicast pair) for the SL-PRS, a resource reservation period, an SL-PRS priority, and a cast type. The SCI of any section may indicate SL-PRS resources in any of the SL-PRS symbols, on a per-resource-element basis, across the entire bandwidth of the resource pool. Different SCI may therefore multiplex SL-PRS resources in the same symbol and PRB, allowing for multiplexing of SL-PRS from several TX UE, as shown for multiple base stations and DL PRS in FIG. 1.

### Resource Indication in Dedicated Resource Pool

PSCCH resources may be assigned index values based on a number of different sub-channels that carry SCI (e.g., 3 as in FIG. 6). The order of the PSCCH indexing may be based on frequency, for example, a lowest frequency subchannel may be assigned the lowest PSCCH index value.

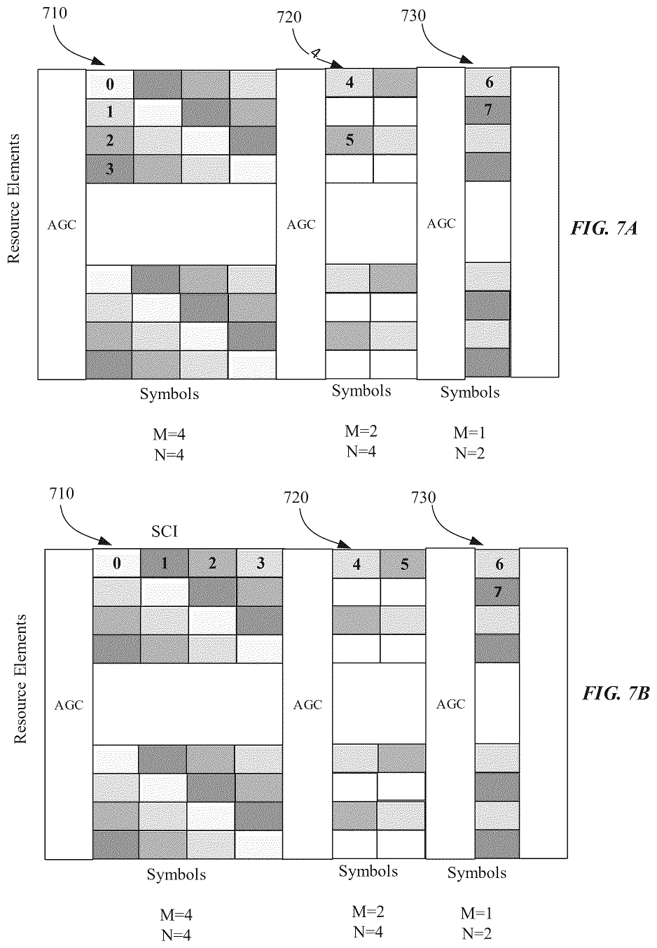

FIGS. 7A and 7B illustrate different conventions for assigning SL-PRS resource index values to SL-PRS resources. In FIGS. 7A and 7B, there are up to four different sets of configured SL-PRS resources, as indicated by the different shading, each set configured by a comb size (N) and differing offset. The dedicated resource pool may include, within a same slot, several SL-PRS blocks or sessions having a number M of consecutive symbols that carry SL-PRS, with each SL-PRS block preceded by an automatic gain control (AGC) symbol. SL-PRS block 710 has a length M of 4 symbols and a comb size 4. SL-PRS block 720 has a length of 2 symbols and a comb size 4. SL-PRS block 730 has a length of 1 symbol and a comb size 2.

FIG. 7A illustrates an SL-PRS resource indexing based on frequency in SL-PRS resource first and SL-PRS resource second. If the bandwidth of the SL-PRS is less than the bandwidth of the dedicated resource pool, SL-PRS resources may be frequency-division multiplexed and the SL-PRS resource indexes may be ordered by frequency. The frequency ordering may start from the “top” frequency of the SL-DRP as shown in FIG. 7A or from the “bottom” frequency of the SL-DRP.

FIG. 7B illustrates an SL-PRS resource indexing based on a symbol in SL-PRS resource first, frequency in SL-PRS resource second, and SL-PRS resource third. If the bandwidth of the SL-PRS is less than the bandwidth of the dedicated resource pool, SL-PRS resources may be frequency-division multiplexed and the SL-PRS resource indexes may be ordered by frequency. Another SL-PRS resource indexing scheme indexes the SL-PRS resources by symbol in SL-PRS resource first, SL-PRS resource second, and frequency in SL-PRS resource third. The index labels in FIG. B also apply in this indexing order.

### Sidelink Control Information for SL-PRS

In addition to indicating a selected SL-PRS resource, when necessary, in some examples, the single stage SCI also indicates a source ID and destination ID that identifies a TX UE/RX UE unicast pair. The source ID and/or destination ID may be indicated by a full 24 bit MAC layer ID, some number of least significant bits (LSB) (e.g., 16 bits) of the 24 bit MAC ID, or other bits based on the source ID/destination ID. The SCI may include bits encoding an SL-PRS priority. Three bits may indicate up to eight different priority levels. The SCI may include bits encoding a cast type. Two bits may be used to indicate one of broadcast, groupcast, or unicast or a single bit may be used to indicate either unicast or groupcast/broadcast.

To indicate a periodic SL-PRS resource that periodically occurs in SL slots during a certain period, the SCI may include b bits (e.g., 4) to indicate a resource reservation period identifier (ID). The resource reservation period ID indicates one of 2^{b} different resource reservation periods. Resource reservation periods that are mapped to the resource reservation period IDs may be (pre-) configured on a per dedicated resource pool basis.

To indicate an aperiodic SL-PRS resource or SL-PRS retransmission resource, the SCI may include bits encoding a subchannel index of a first transmission of the SL-PRS. Depending on a configuration of an SL maximum number of resources per reservation (e.g., sl-MaxNumPerReserve), the SCI may also encode a subchannel index of a first retransmission of the SL-PRS, and, when the maximum number of resources per reservation is 3, a subchannel index of a second retransmission of the SL-PRS. When there are more than one SL-PRS mapped to each PSCCH, for an aperiodic SL-PRS resource or SL-PRS retransmission resource, the SCI may also include bits encoding an SL-PRS resource index of a first transmission of the SL-PRS. Depending on a configuration of an SL maximum number of resources per reservation, the SCI may also encode an SL-PRS resource index of a first retransmission of the SL-PRS, and, when the maximum number of resources per reservation is 3, an SL-PRS resource index of a second retransmission of the SL-PRS.

The SCI may also be used by an RX UE to transmit a layer-1 RSRP report (e.g., raw RSRP measurements) or layer-3 RSRP report (e.g., filtered RSRP value).

The SL-PRS sequence may be mapped in sequence starting from n(0) resource elements (k (time), l (frequency)) in a slot on an antenna port that is different from an antenna port assigned to PSSCH. The mapping is according to the following relationship, where a is the signal to be allocated to each resource element and β is a power control factor:

$${α}_{k , l}^{( p , μ )} = {β}_{SL - PRS} \cdot r ( m ) \qquad EQ . 1$$

$$m = 0 , 1 , ...$$

$$k = m \cdot {K}_{comb}^{SL - PRS} + ( ( {k}_{offset}^{SL - PRS} + {k}^{′} ) mod {K}_{comb}^{SL - PRS} ) \qquad EQ . 2$$

$$l = {l}_{start}^{SL - PRS} , {l}_{start}^{SL - PRS} + 1 , ... , {l}_{start}^{SL - PRS} + {L}_{SL - PRS} - 1 \qquad EQ . 3$$

where the resource element (k,l)_{p,μ} is within resource blocks occupied by the sidelink PRS resource for which the UE is configured;

$${l}_{start}^{SL - PRS}$$

is the first symbol of the SL-PRS within a slot and given by the higher-layer parameter sl-PRS-ResourceSymbolOfffset; L_{SL-PRS}−1 is the size of the SL-PRS resource in the time domain and is an element of {1,2,4,6,12} given by the higher-layer parameter of sl-PRS-NumSymbols. The comb size

$${K}_{comb}^{SL - PRS}$$

is an element of {1,2,6,12 and is given by higher-layer parameter sl-PRS-CombSizeN-AndReOffset for a comb SL PRS resource. The resource-element offset

$${K}_{offset}^{SL - PRS} ∈ \{ 0 , 1 , ... , {K}_{comb}^{SL - PRS} - 1 \}$$

is obtained from higher-layer parameter sl-PRS-CombSizeN-AndReOffset. The quantity k′ used in the calculation of the time parameter k is given by the table of FIG. 8.

The reference point for k=0 may be (pre-) configured by resource pool as a location of point A, which is the common reference point of the SL-BWP. Otherwise, the reference point may be subcarrier 0 in the common resource block 0. In other examples, the reference point is the lowest subcarrier in the lowest PRB of the resource pool or SL BWP or a (pre-) configured or defined offset of the lowest subcarrier in the lowest PRB of the resource pool or SL BWP.

### PSCCH to SL-PRS Resource Mapping

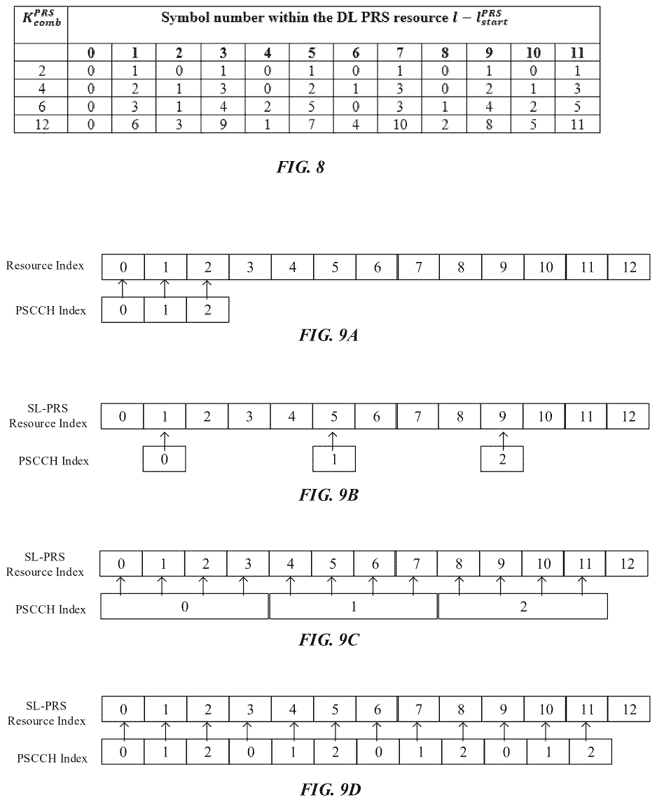

To simplify signaling overhead, there may be a mapping of PSCCH resources and SL-PRS resources. FIGS. 9A-9D illustrate several different types of mapping that may be (pre-) configured on a per dedicated resource pool basis. As illustrate in FIGS. 9A and 9B, there may be a one-to-one mapping between PSCCH index and SL-PRS index. FIG. 9A illustrates a one-to-one mapping in which the i^{th} PSCCH resource index (0≤i≤X−1) is associated with the i^{th} SL-PRS resource in the slot. FIG. 9B illustrates a one-to-one mapping in which the i^{th} PSCCH resource index is mapped to a single SL-PRS resource, where the SL-PRS resource may not have the same index value as the PSCCH resource index. In the example of FIG. 9B, the i^{th} PSCCH index is mapped to the

$${( ⌊ \frac{Y}{X} ⌋ \cdot i + j )}^{th} SL - PRS$$

resource index. X is the number of subchannels, which correspond to PSCCH resource indices, and Y is the number of SL-PRS resources in the slot.

$$⌊ \frac{Y}{X} ⌋$$

is the floor operation. A ceiling operation may also be used for determining the mapping. The value for j may be (pre-) configured on a per dedicated resource pool basis. In FIG. 9B, X is 3, Y is 13, and j is 1 so that the PSCCH index value 0 is mapped to the SL-PRS resource having index value 1, and so on.

As illustrated in FIGS. 9C and 9D, the may be a one-to many mapping between PSCCH index and SL-PRS resource index. In this case, an additional parameter in the SCI will indicate which of a (pre-) configured set of SL-PRS resources mapped to the associated PSCCH will carry the SL-PRS (e.g., using an SL-PRS resource index value). As shown in FIG. 9C, each PSCCH index may be mapped to a set of contiguous SL-PRS resource indexes. For example, the i^{th} PSCCH index may be mapped to SL-PRS resource index values

$$\{ ⌊ \frac{Y}{X} ⌋ \cdot i , ⌊ \frac{Y}{X} ⌋ \cdot i + 1 , ⌊ \frac{Y}{X} ⌋ \cdot i + 2 , ... , ( i + 1 ) \cdot ⌊ \frac{Y}{X} ⌋ - 1 \} .$$

As shown in FIG. 9D, each PSCCH index may be mapped to a set of interleaved SL-PRS resource indexes. For example, the i^{th} PSCCH index may be mapped to SL-PRS resource index values

$$\{ i , i + X , i + 2 X , ... , i + ⌊ \frac{Y}{X} ⌋ \cdot X \} .$$

The floor operation may be replaced by a ceiling operation.

In other examples, there is no pre-determined mapping of PSCCH resources to SL-PRS resources, in which case the single stage SCI will indicate one SL-PRS resource (e.g., using an SL-PRS resource index value) out of all candidate SL-PRS resources in the slot that has been selected for the SL-PRS.

### Transmission of SL-PRS in Scheme 2

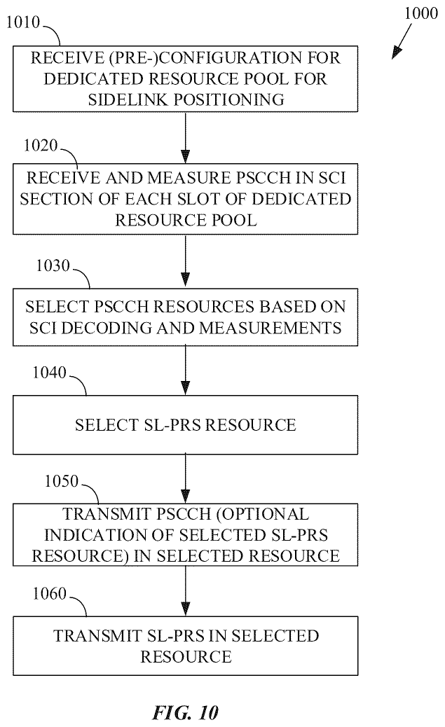

FIG. 10 is a flow diagram outlining an example method 1000 that may be performed by a TX UE to transmit SL-PRS when the TX UE is operating according to scheme 2 in which the TX UE selects from amongst resources of a preconfigured resource pool rather than receiving an allocation from the network. The method 1000 includes, at 1010, receiving a (pre-) configured dedicated resource pool for use for SL positioning. An example dedicated resource pool is illustrated in FIG. 6. At 1020, in a manner similar to the legacy PSCCH/PSSCH candidate selection process outlined above with reference to FIG. 4 mode 2, the TX UE receives and measures PSCCH/SCI of each slot of the dedicated resource pool. The TX UE may measure RSRP of signals, such as demodulation reference signals (DM-RS) associated with or included in the PSCCH.

At 1030, the UE selects PSCCH resources using a process similar to the legacy PSCCH/PSSCH resource selection process outlined above with reference to FIG. 4 mode 2. When a sensed SCI indicates a periodic SL-PRS resource, the TX UE assumes that the same SL-PRS resource will be scheduled in a slot in each period of the resource reservation period. When there is a one-to-one mapping between PSCCH resources and SL-PRS resources, candidate resources may be defined in terms of a sub-channel for PSCCH and slot. This is because due to the one-to-one mapping, any colliding PSCCH in a same slot will be indicating the same SL-PRS resources. In this manner, only a sub-channel (e.g., that is assigned to the TX UE) need be selected. This is different from legacy PSCCH/PSSCH candidate resource selection in which one or more sub-channels may be selected.

When there is no mapping of PSCCH resources to SL-PRS resources, candidate resources may be defined in terms of the individual SL-PRS resource and slot.

The TX UE receives, in the SCI for slot

$${t}_{m}^{′ SL} ,$$

a resource reservation period and a priority of the associated SL-PRS. The TX UE excludes any single slot candidate resource R_{w,y} from the set SA if the RSRP measurement for the SCI is higher than a threshold. The threshold is selected based on the priority of the SL-PRS to be transmitted by the TX UE and the priority of SL-PRS to be transmitted by other UEs. The SL-PRS are assumed to be scheduled in slots(s)

$${t}_{m + q \cdot {P}_{{rsvp}_{RX}}^{′}}^{SL}$$

according to a resource indication which determines the set of SL-PRS resources and slot which overlap with

$${R}_{w , y + j \cdot {P}_{{rsvp}_{Tx}}^{′}}$$

for q=1, . . . , Q and j=0, . . . , Cᵣₑₛₑₗ₋₁. If, after the exclusion, insufficient candidate resources remain, the TX UE may perform reselection using a different threshold as outlined above in the legacy PSCCH/PSSCH resource selection process to arrive at a sufficient set of candidate resources. The TX UE selects a PSCCH resource from the set of candidate resources. The TX UE may select a random PSCCH resource from the set or use another selection criteria.

At 1040, the UE selects an SL-PRS resource. When there is a mapping between PSCCH resources and SL-PRS resources, the TX UE selects an SL-PRS according to the mapping with respect to the selected PSCCH resources. When there is no mapping between PSCCH resources and SL-PRS resources, the TX UE may select any SL-PRS resource in the slot. When the TX UE selects from more than one SL-PRS resource, the selection may be based on a priority of the SL-PRS, a resource reservation periodicity, an SL channel busy ratio, and/or SL channel occupancy ratio.

At 1050, the TX UE transmits PSCCH including SCI in the selected candidate resource. As discussed above the SCI may indicate an SL-PRS resource when there is not a (pre-) configured one-to-one mapping between PSCCH resources and SL-PRS resources. At 1060, the TX UE transmits SL-PRS in the selected SL-PRS resource.

The SL-PRS transmission method 1000 may also include a pre-emption check similar to the pre-emption check disclosed above with reference to the legacy PSCCH/PSSCH resource selection process. This pre-emption check may be an optional feature that is enabled/disabled in the dedicated resource pool configuration. At a pre-emption time interval prior to the scheduled time for transmitting the SL-PRS, the TX UE senses SCI and compares a priority of any other UE's scheduled SL-PRS that overlap with the SL-PRS to be transmitted by the TX UE with a priority of the SL-PRS to be transmitted by the TX UE. If an overlapping higher priority SL-PRS is scheduled, the TX UE performs resource re-selection.

In one example, when there is a mapping between PSCCH resources and SL-PRS resources, the resource for the pre-emption check is a sub-channel and the mapped SL-PRS. When there is no mapping between PSCCH resources and SL-PRS resources, the resource for the pre-emption check is all SL-PRS resource in the slot.

### Scheme 1 Resource Allocation for SL-PRS

In scheme 1, the network allocates resources to a TX UE for SL-PRS by way of a resource allocation. The resource allocation may be downlink control information (DCI) or a configured grant.

DCI format 3_0 may be adapted for allocating resources for SL-PRS. The following fields in existing DCI format 3_0 are not needed and may be repurposed: “lowest index of the sub-channel allocation to the initial transmission” field; “SCI format 1-A/frequency resource assignment” field; “PUCCH resource indicator” field; “PSFCH-to-HARQ feedback timing indicator” field; “new data indicator” field; “HARQ process number” field; and “counter sidelink assignment index” field. The following fields may be kept from DCI format 3_0: “resource pool index” field; “time gap” field; “SCI format 1-A/time resource assignment” field; and “configuration index” field.

The following new fields that are not included in DCI format 3_0 may be added to the DCI: “subchannel index of the initial transmission” field; “subchannel index of the first retransmission” field; and “subchannel index of the second retransmission” field. Each of these fields will have

$$⌈ {log}_{2} ( {N}_{subchannel}^{SL} ) ⌉$$

bits. Additional new fields include “SL-PRS resource index of the initial transmission” field; “SL-PRS resource index of the first retransmission” field; “SL-PRS resource index of the second retransmission” field. Each of these fields will have

$$⌈ {log}_{2} ( {N}_{SL - PRS}^{PSCCH} ) ⌉$$

bots, where

$${N}_{SL - PRS}^{PSCCH}$$

is the number of SL-PRS resources associated with a PSCCH resource. It is noted that any of these new fields may be empty when there is a one-to-one mapping between PSCCH resources and SL-PRS resources or if the selection of the SL-PRS resource from amongst several SL-PRS resources is left to the TX UE and is not selected by the network.

When an adapted DCI format 3_0 is used for scheme 1 SL-PRS resource allocation, the DCI may be scrambled according to an SL-PRS-DRP random network temporary identifier (RNTI) or an SL-PRS configured scheduled (CS) DRP RNTI if the dedicated resource pool uses a different RNTI than a legacy sidelink RNTI. If the dedicated resource pool uses the same RNTI as the legacy sidelink, the DCI may be scrambled according to an SL-PRS-RNTI or SL-PRS-CS-RNTI. The fields that are not needed from the legacy DCI format 3_0 may be reserved or re-interpreted as the new fields identified above. In an alternative approach, a new DCI format 3_X may be provided that does not include fields not necessary for scheduling SL-PRS resources.

For a shared resource pool, the following new fields that are not included in DCI format 3_0 may be added to the DCI: “SL-PRS resource index of the initial transmission” field; “SL-PRS resource index of the first retransmission” field; “SL-PRS resource index of the second retransmission” field. Each of these fields will have

$$⌈ {log}_{2} ( {N}_{SL - PRS}^{PSCCH} ) ⌉$$

bits, where

$${N}_{SL - PRS}^{PSCCH}$$

is the number of SL-PRS resources associated with a PSCCH resource. It is noted that any of these new fields may be empty when there is a one-to-one mapping between PSCCH resources and SL-PRS resources.

When a configured grant is used to allocate resources for SL-PRS, a new IE may be provided (e.g., called SL_PRS_ConfiguredGrantConfig) that incudes the following fields: sl-PRS-ConfigIndexCG and sl-PRS-PeriodCG. For type 1 configured grants (that do not require DCI activation), a field rrc-ConfiguredSidelinkGrant is also included which provides an indication of the following parameters: sl-PRS-TimeResourceCG-Type1, sl-PRS-SubchannelCG-InitialTx-Type1, sl-PRS-SubchannelCG-ReTx1-Type1, sl-PRS-SubchannelCG-ReTx2-Type1, sl-PRS-TimeOffsetCG-Type 1, sl-PRS-TimeReferenceSFN-Type1, sl-PRS-ResourcePoolID, sl-PRS-ResourceIndexCG-InitialTx-Type 1, sl-PRS-ResourceIndexCG-ReTx-Type 1, and sl-PRS-ResourceIndexCG-ReTx2-Type 1.

### Configuration Information and Source ID/Destination ID in Dedicated Resource Pools

As compared with legacy SL communication in which unicast links are established for the purpose of transmitting SL data, in SL positioning, a UE may request SL-PRS from a TX UE with which it does not currently have a unicast link. When the UE is configured with a dedicated resource pool for SL-PRS, there are no resources for exchanging configuration and capability information. To address this issue, a shared resource pool may be linked to the dedicated resource pool in the configuration of the dedicated resource pool or a default shared resource pool may be (pre-) configured for use in requesting SL-PRS. The linking between shared and dedicated resource pools may be accomplished by identifying a linked pool in configurations of one or both of the linked pools. The UE uses resources of this linked or default shared resource pool to establish a unicast link with the TX UE to exchange configuration and capability information, open loop power configuration information (e.g., RSRP measurements or filtered value), and so on. Once the unicast link is established, a different shared resource pool may be linked to the dedicated resource pool for future data transmissions between the UEs.

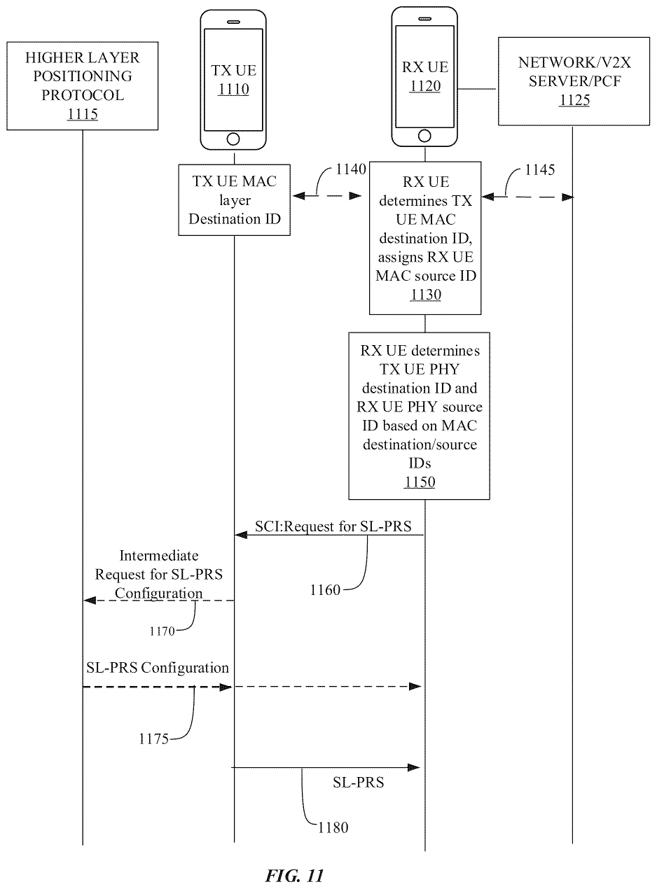

Another challenge presented by the dedicated resource pool is that there are no resources (e.g., PSSCH) for exchanging PHY layer source and destination IDs, which are included in SCI requesting SL-PRS. FIG. 11 is a message flow diagram outlining a process by which an RX UE 1120 may request and receive SL-PRS from a TX UE 1110 with which it does not have a unicast link. At 1130, the RX UE determines a MAC destination ID for the TX UE and self-assigns an RX UE MAC layer source ID. The UE may use one of several possible techniques to determine the TX UE MAC layer destination ID at 1120.

In one alternative, the RX UE uses resources of a linked or default shared resource pool (as described above) to establish a unicast link 1140 with the TX UE to provide the TX UE with the RX UE's MAC layer source ID and to determine the TX UE's MAC layer destination ID. There may be a one-to-one mapping between shared resource pools, a specific shared resource pool may be linked to more than one dedicated resource pool, or a specific dedicated resource pool may be linked to more than one shared resource pool. A UE may use the same or different source IDs for the dedicated resource pool and the shared resource pool.

The configuration for a dedicated resource pool may identify shared resource pools to which it is linked. The configuration for a shared resource pool may identify dedicated resource pools to which it is linked. In other examples, the linking between dedicated resource pools and shared resource pools is provided by higher layers, for example in conjunction with providing sequence generation parameters. A unique identifier for a dedicated resource pool or a shared resource pool may be used to identify a particular resource pool in a linked pool's configuration. This linked resource pool may be identified by a resource pool ID, a resource pool configuration (e.g., SL-ResourcePool information element), or resource pool time and frequency resources.

In another alternative, the RX UE 1120 determines the TX UE MAC layer destination ID based on a positioning application ID assigned to the TX UE 1110 by the RX UE using a positioning application or by (pre-) configuration. In this approach, a default positioning application layer ID may be defined and/or a user defined positioning application layer ID may be created. In sidelink policy/parameter provisioning when NR PC5 is selected, to support SL positioning, a mapping of vehicle-to-everything (V2X) services types to the default mode of communication and/or positioning is provided. Further, a mapping of V2X service types to MAC layer destination ID is established for broadcast, groupcast, and initial signaling to establish unicast link for communication and/or positioning.

In a third alternative, the MAC layer destination ID may be determined based on a dedicated resource pool configuration that is (pre-) configured in the RX UE or a SIM card. In other examples, the MAC layer destination ID may be provided by signaling 1145 from a network device 1125 such as a V2X server or an update received from a policy control function (PCF).

At 1150, the RX UE determines the PHY layer TX UE destination ID and RX UE source ID based on the MAC layer destination ID and source ID determined at 1130. The PHY layer ID may correspond to a certain number of LSBs of the MAC layer ID. At 1160, the RX UE 1120 sends SCI to the TX UE 1110 using the PHY layer destination ID to request SL-PRS from the TX UE. The SCI may be transmitted in a shared resource pool or a dedicated resource pool and may request SL-PRS in a shared resource pool or a dedicated resource pool.

In some examples, the TX UE 1110 may select resources in scheme 1 or scheme 2 as described above with respect to FIGS. 7-10 and transmit SL-PRS at 1180. In other examples, as illustrated in FIG. 11 the TX UE 1110 sends an intermediate request for SL-PRS configuration 1170 to a higher layer positioning protocol 1115 such as a sidelink positioning protocol (SPP), a new radio positioning protocol (NRPPa), or a long term evolution positioning protocol (LPP). Then the higher layer positioning protocol transmits an SL-PRS configuration 1175 to the TX UE and RX UE scheduling the SL-PRS and triggering the TX UE to transmit SL-PRS 1180 to the RX UE.

### Open Loop Power Configuration in Dedicated Resource Pool

As disclosed above, open loop power configuration (OLPC) for transmit power of PSCCH/PSSCH may be based on (DL) pathloss only, SL pathloss only, or both DL pathloss and SL pathloss. OLPC for transmission of PSCCH and SL-PRS in a dedicated resource pool may be likewise based on DL pathloss only, SL pathloss only, or both DL pathloss and SL pathloss. However, to determine SL pathloss, in legacy OLPC, the TX UE needs to receive, from the RX UE, an average or filtered RSRP value based on measurements made by the RX UE for the TX UE's PSCCH DMRS or other reference signal. The TX UE uses the filtered RSRP value along with the transmit power of the measured PSSCH to determine the SL pathloss (SL pathloss=filtered RSRP−PSSCH transmit power). There are no PSSCH resources in the dedicated resource pool to carry a filtered RSRP value or raw RSRP measurement data. Thus, modifications to the legacy OLPC should be made to support use of the dedicated resource pool for SL-PRS.

In one example, only DL pathloss is used to determine the PSCCH and SL-PRS transmit power when the UE is in coverage. If the UE is not in coverage, OLPC is not supported and the UE transmits PSCCH and SL-PRS at maximum power (Pc_max).

In another example, a shared resource pool may be linked to the dedicated resource pool as disclosed above with reference to FIG. 11 or a default shared resource pool may be (pre-) configured for use in SL positioning. The TX UE may use the linked or default shared resource pool to initiate a unicast link with the RX UE and use the unicast link to receive RSRP feedback from the RX UE. The shared resource pool may include PSSCH resources that may be used to carry the RSRP feedback, such as a filtered RSRP value on a media access control (MAC) control element (CE) or using a legacy SL communication method on PSSCH. This feedback is used to determine SL pathloss for determining PSCCH and SL-PRS transmit power.

In another example, the TX UE receives a PHY layer RSRP report or an RRC layer RSRP report that is transmitted by the RX UE in the PHY layer using single stage SCI.

In another example, the RX UE transmits a PHY layer RSRP report to the RX UE. In one option of this approach, the RX UE performs filtering or averaging of several RSRP measurements and feeds back the resulting filtered RSRP value. In another option, the RX UE transmits measurement results to the TX UE and an RRC layer of the TX UE performs the filtering on the measurement results to compute the filtered RSRP value. The measurement results may be transmitted in single stage SCI of the dedicated resource pool. In another option, the RX UE computes the SL pathloss. SL pathloss is determined based on a difference between the transmit power of the reference signals (e.g., PSCCH Tx power) reduced by the filtered RSRP value. In this approach, the RX UE may receive an indication of the transmit power of the reference signals transmitted by the TX UE. This indication of reference signal transmit power may be included in single stage SCI of the dedicated resource pool that is transmitted to the RX UE. The RX UE may also use single stage SCI to communicate a calculated SL pathloss or RSRP feedback (e.g., RSRP measurements or filtered RSRP value) to the TX UE. The bit width within the single stage SCIs for encoding the transmit power (when SCI is sent by TX UE) and the RSRP feedback (when SCI is sent by RX UE) may be fixed or configurable, with different granularities/resolutions for transmit power as compared to RSRP feedback being optionally supported.

In another example, the transmit power for PSCCH is determined using a formula that determines transmit power in legacy PSSCH symbols where a corresponding PSCCH is not transmitted.

In another example, the SL-PRS transmit power in a symbol is equal to the total power of PSCCH in a dedicated resource pool. Alternatively, the SL-PRS transmit power per resource element (RE) is equal to the transmit power of PSCCH per RE, which is determined based on the following relationship

$${P}_{SL - PRS} ( i ) = 10 {log}_{10} ( \frac{{M}_{RB}^{SL - PRS} ( i )}{{M}_{RB}^{PSCCH} ( i )} ) + {P}_{PSCCH} ( i )$$

where

$${M}_{RB}^{SL - PRS} ( i )$$

is the number of PRBs pf SL-PRS;

$${M}_{RB}^{PSCCH} ( i )$$

is the number of PRBs of PSCCH. In some examples,

$${M}_{RB}^{SL - PRS} ( i )$$

may be replaced with

$${M}_{RE}^{SL - PRS} ( i ) and {M}_{RB}^{PSCCH} ( i )$$

may be replaced with

$${M}_{RE}^{PSCCH} ( i ) ,$$

where with

$${M}_{RE}^{SL - PRS} ( i )$$

is the number of REs SL-PRS and with

$${M}_{RE}^{SL - PRS} ( i )$$

is the number of REs of PSCCH.

### Timing Indication for SL-PRS

Positioning information may be determined based on difference between SL-PRS receive time and SL-PRS transmission time. The TX UE may report an actual SL-PRS transmission time to the entity performing the positioning related calculation to be used for computation of a transmission time/receive or measurement time difference measurement.

In some aspects, to support communication of the SL-PRS transmission time, an absolute time duration is signaled in terms of a physical layer time unit (Tc) which is a fixed quantity defined by TS 38.211. The absolute time duration may be configured using RRC signaling and/or may be transmitted by a positioning protocol from a location management function (LMF). In the SL-PRS transmission time report, the actual transmission time will be expressed as a quantity of total Tcs within the absolute time duration. The absolute time duration may be defined as a slot, subframe, or frame. The granularity of the absolute transmission time in the transmission report will thus be based on the absolute time duration. The granularity of the absolute transmission time may be (pre-) configured on a per resource basis, a per resource pool basis, or a per positioning basis.

The TX UE reports the absolute transmission time as a quantity of Tcs (Tc (transmit)) within the absolute time duration. The absolute transmission time report may report an actual Tc (transmit) or a quantized Tc (transmit) value, where the Tc quantization level may be configured and will determine a number of bits used to signal the transmission time in the report. Tables 1 and 2 below illustrate different examples of numbers of bits that may be used to quantize the absolute transmission time when the absolute time duration is a subframe (Table 1) or when the absolute time duration is slot (Table 2). Note that when a slot is the absolute time duration, the number of Tcs per slot will vary based on the subcarrier spacing used, as will a number of bits needed to encode Tc (transmit). Similar techniques may be used to signal an SL-PRS receive or measurement time.

In some examples, the absolute time spans a subframe or slot boundary. For example, the absolute time duration over a subframe (1 ms) may range from −0.5 ms or −1966080/2 Tcs to 0.5 ms or 1966080/2 Tcs.

TABLE 1
Subframe

| | | | Tc per | | Quanti- | 4Tc per | |
|---|---|---|---|---|---|---|---|
| | | | Sub- | | zation | sub- | |
| SCS | Subframe | Tc | frame | #bits | Size | frame | #bits |
| 15 | 1.00E−03 | 5.08626E−10 | 1966080 | 21 | 4 | 491520 | 19 |
| 30 | 1.00E−03 | 5.08626E−10 | 1966080 | 21 | 4 | 491520 | 19 |
| 60 | 1.00E−03 | 5.08626E−10 | 1966080 | 21 | 4 | 491520 | 19 |
| 120 | 1.00E−03 | 5.08626E−10 | 1966080 | 21 | 4 | 491520 | 19 |
| 480 | 1.00E−03 | 5.08626E−10 | 1966080 | 21 | 4 | 491520 | 19 |
| 960 | 1.00E−03 | 5.08626E−10 | 1966080 | 21 | 4 | 491520 | 19 |

TABLE 2
Slot

| | | Slots per | Slot | | Tc per | | Quantization | 8Tc per | |
|---|---|---|---|---|---|---|---|---|---|
| SCS | Subframe | Subframe | Duration | Tc | Subframe | #bits | Size n = 8 | subframe | #bits |
| 15 | 1.00E−03 | 1 | 1.00E−03 | 5.08626E−10 | 1966080 | 21 | 8 | 245760 | 18 |
| 30 | 1.00E−03 | 2 | 5.00E−03 | 5.08626E−10 | 983040 | 20 | 8 | 122880 | 17 |
| 60 | 1.00E−03 | 4 | 2.50E−03 | 5.08626E−10 | 491520 | 19 | 8 | 61440 | 16 |
| 120 | 1.00E−03 | 8 | 1.25E−03 | 5.08626E−10 | 245760 | 18 | 8 | 30720 | 15 |
| 480 | 1.00E−03 | 32 | 3.13E−05 | 5.08626E−10 | 61440 | 16 | 8 | 7680 | 13 |
| 960 | 1.00E−03 | 64 | 1.56E−05 | 5.08626E−10 | 30720 | 15 | 8 | 3840 | 12 |

When the transmission time occurs in one duration (e.g. a first slot, subframe, frame) and the receive time occurs in another duration (e.g., a second slot, subframe, frame) so that Tc (transmit absolute time)>Tc (receive absolute time), different compensation measures may be taken by an LMF or other entity that receives the transmission time or measurement/receive time for positioning calculations. In one example, the LMF may discard the measurement. In another example, the LMF may estimate the correct time difference assuming that the receive time occurs in an immediately subsequent time duration (e.g., using a modulo operation). In another example, the LMF reconfigures the absolute time to be defined over an increased duration. In another example, an explicit signal is used to indicate if the measurement is in a same duration period (e.g., the same subframe or slot). For example, if the transmit time and receive time are in the same duration period, a single bit may be set to 0 and if the transmit time and receive time are in subsequent duration periods, the bit may be set to 1. If more than two duration periods may be spanned between the transmission time and the receive time, more bits may be used to signal the number of duration periods spanned by the transmission time and the receive time.

The absolute time may be defined based on an orthogonal frequency division multiplexing (OFDM) symbol start of transmission/measurement of the SL-PRS. For example, an information element nr-TimeStamp-RxTx may define the UE measurement/transmission associated time stamp. The IE may includes an nr-SFDN field that specifies the NR system frame number (SFN) for UEs that are in coverage or the NR direct frame number (DFN) for UEs that are out of coverage. A field nr-Slot may specify the NR slot number within the NR SFN or DEN indicated by the nr-SFDN field. A field nr-symbol may specify the NR OFDM symbol number within the slot indicated by the nr-Slot field. A field Tc_value may encode the timestamp in terms of Tcs over a symbol, slot, or subframe.

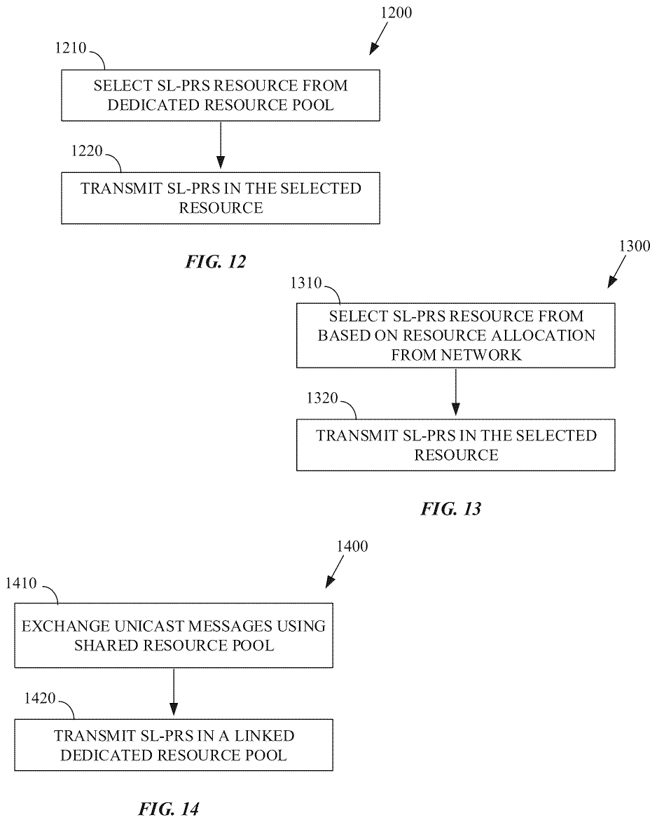

FIG. 12 is a flow diagram outlining an example method 1200 for transmitting SL-PRS using a dedicated resource pool. The method 1200 may be performed by TX UE 401 and/or 1110 of FIGS. 4 and 11, respectively. The method includes, at 1210 selecting a sidelink positioning reference signal (SL-PRS) resource from a configured or preconfigured dedicated resource pool. The dedicated resource pool includes candidate physical sidelink control channel (PSCCH) resources configured to carry single stage sidelink control information (SCI) and candidate SL-PRS resources, wherein the dedicated resource pool does not include candidate resources for physical sidelink shared channel (PSSCH) transmission. An example dedicated resource pool is illustrated in FIG. 6. The method includes, at 1220, transmitting the SL-PRS in the selected SL-PRS resource.

In some aspects, the method includes selecting periodic SL-PRS resources that occur in the same frequency domain resources in a same slot of each SL-PRS resource period during a reservation period. The method may include selecting aperiodic SL-PRS resources.

Each candidate SL-PRS resource is indicated by a slot index and a sub-channel index or a slot index and an SL-PRS resource index. In some examples, as illustrated in FIGS. 7A and 7B, PSCCH resources in slot in the dedicated resource pool are indexed in terms of frequency location. As shown in FIG. 7A, SL-PRS resources in a slot in the dedicated resource pool may be indexed in order of frequency in an SL-PRS resource first, and by SL-PRS resource second. Alternatively, as shown in FIG. 7B, SL-PRS resources in a slot are indexed in order of symbol in an SL-PRS resource first, frequency in an SL-RS resource second, and SL-PRS resource third; or in order of symbol in an SL-PRS resource first, SL-PRS resource second, and frequency third.

As illustrated in FIGS. 9A-9D, each PSCCH resource may be mapped to one SL-PRS resource, where a mapped SL-PRS resource index is the same as a PSCCH resource index or the mapped SL-PRS resource index is different from the PSCCH resource index. Alternatively, each PSCCH may be mapped to a set of SL-PRS resources the method then includes transmitting an indication of a selected one of the set of SL-PRS resource in single stage SCI carried by the PSCCH resource. The set of SL-PRS resources have consecutive SL-PRS resource indices or interleaved SL-PRS resource indices. The method may include selecting an SL-PRS resource from amongst the set of SL-PRS resources based on one or more of a priority associated with the SL-PRS, a resource reservation periodicity, a SL channel busy ratio, or a SL channel occupancy ratio.

As shown in FIG. 10, the method may include selecting the SL-PRS resource from the dedicated resource pool by measuring a reference signal receive power (RSRP) of single stage SCI in candidate PSCCH of the dedicated resource pool; decoding the single stage SCI to determine a resource reservation period and priority of respective SL-PRS associated with respective SCI; and excluding, from the candidate resource pool, candidate resources associated with single stage SCI having a higher RSRP than a threshold. The threshold is selected based on a priority indicated in the single stage SCI or a priority of the SL-PRS.

The method may include, at a pre-emption time interval prior to the selected SL-PRS resource, decoding single stage SCI to determine if the selected SL-PRS resource is reserved for a higher priority SL-PRS; and refraining from transmitting the SL-PRS when the selected SL-PRS resource is reserved for a higher priority SL-PRS. The method may include decoding single stage SCI in a same sub-channel as the selected SL-PRS resource and compare a priority of SL-PRS associated with the single stage SCI with the priority of the SL-PRS to be transmitted. The method may include decoding single stage SCI in all sub-channels of the dedicated resource pool and compare a priority of respective SL-PRS associated with the single stage SCI with the priority of the SL-PRS to be transmitted.

In some examples, the single stage SCI includes an indication of one or more of a source ID for the UE, a destination ID for a receive (RX) UE, a priority of an associated SL-PRS, a resource reservation period, an aperiodic resource reservation, an SL-PRS resource indicator for a first transmission, an SL-PRS resource indicator for a re-transmission of the SL-PRS, a PHY layer reference signal receive power (RSRP) report, or a an RRC layer RSRP report.

In some examples, the method includes mapping an SL-PRS sequence to resource elements in a slot on an antenna port based on a configured or preconfigured comb size and a comb offset, wherein the comb offset is defined relative to a reference point. The antenna port may be different from an antenna port used to transmit PSCCH. The reference point may be a common reference point A associated with Uu link communication, a lowest subcarrier in a lowest physical resource block of the dedicated resource pool or a sidelink bandwidth part, or a configured or predefined offset from a lowest subcarrier in a lowest physical resource block of the dedicate resource pool or a sidelink bandwidth part.

FIG. 13 is a flow diagram outlining an example method 1300 for transmitting SL-PRS based on a resource allocation from a network. The method 1300 may be performed by TX UE 401 and/or 1110 of FIGS. 4 and 11, respectively. The method includes, at 1310, selecting a sidelink positioning reference signal (SL-PRS) resource based on a resource allocation received from a network. At 1320, the method includes transmitting the SL-PRS in the selected SL-PRS resource.

The resource allocation may indicate one or more of a shared resource pool index, dedicated resource pool index, a time gap, an SCI format 1-A/time resource assignment, a configuration index, a sub-channel index of a first SL-PRS transmission, a sub-channel index of an SL-PRS re-transmission, an SL-PRS resource index of a first SL-PRS transmission, an SL-PRS resource index of an SL-PRS re-transmission.

In some aspects, the resource allocation corresponds to downlink control information (DCI) that identifies the UE based on an SL-PRS radio network temporary identifier (RNTI) or an SL-PRS configured scheduled RNTI that is assigned to the UE based on the dedicated resource pool. In other aspects, the resource allocation corresponds to a configured grant that indicates one or more of an SL-PRS configured grant configuration index, an SL-PRS configured grant period, a time resource of the configured grant, a time offset of the configured grant, a time reference system frame number of the SL-PRS, a dedicated resource pool identifier.

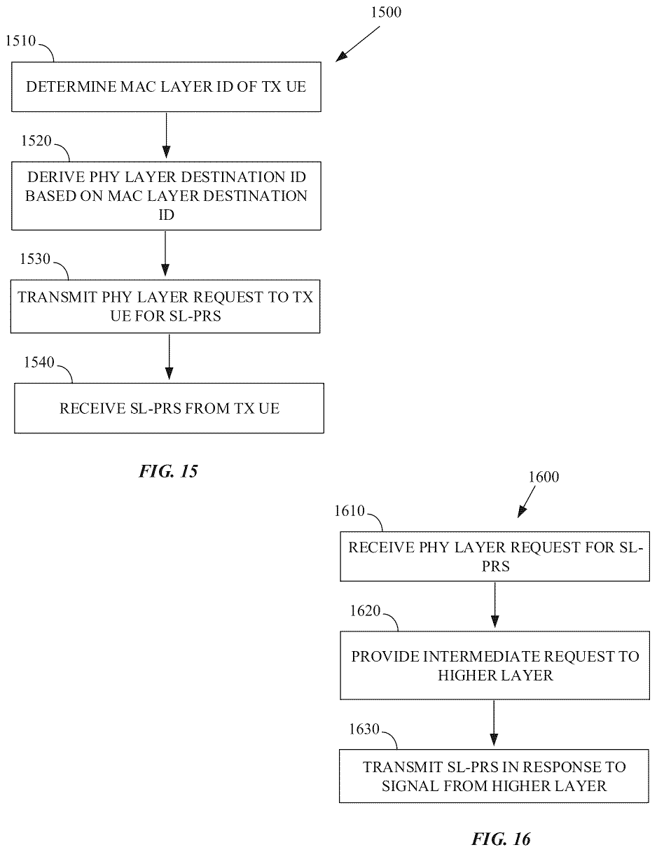

FIG. 14 is a flow diagram outlining an example method 1400 for transmitting SL-PRS using a dedicated resource pool. The method 1400 may be performed by TX UE 401 and/or 1110 of FIGS. 4 and 11, respectively. The method includes, at 1410, exchanging unicast messages with a second UE using resources of a shared resource pool. The method includes, at 1420, transmitting or receiving sidelink positioning reference signals (SL-PRS) using SL-PRS resources of a dedicated resource pool, wherein the dedicated resource pool is linked to the shared resource pool by configuration or pre-configuration.

In some examples, the method includes establishing a unicast link with the second UE using resources of the shared resource pool; receiving a destination identifier (ID) or a source ID from the second UE using resources of the shared resource pool; and transmitting or receiving SL-PRS based on the received destination ID or source ID. The method may include receiving an UE capability information or an open loop power configuration using the unicast link. The method may include transmitting SL data using resources of the dedicated resource pool, a different shared resource pool that is linked to the dedicated resource pool, or a different dedicated resource pool.

FIG. 15 is a flow diagram outlining an example method 1500 for requesting transmission of SL-PRS using a dedicated resource pool. The method 1500 may be performed by RX UE 402 and/or 1120 of FIGS. 4 and 11, respectively. The method includes, at 1510 determining a MAC layer destination ID of a transmit (TX) UE. As shown in FIG. 11, the method may include determining the MAC destination ID by establishing a unicast link with TX UE using a shared resource pool that is linked to the dedicated resource pool, wherein the UE is configured or preconfigured with the shared resource pool or the dedicated resource pool; and determining the MAC layer destination ID based on the unicast link. The shared resource pool may be linked to more than one dedicated resource pool and/or the dedicated resource pool may be linked to more than one shared resource pool.

In another examples, the method includes determining a MAC layer source ID based on either the dedicated resource pool or the shared resource pool. The shared resource pool and the dedicated resource pool may be identified by a resource pool identifier (ID), a resource pool configuration indicated in an information element, or by resource pool time and frequency resources. The method may include determining the shared resource pool based on a configuration or preconfiguration of the dedicated resource pool. The method may include determining the dedicated resource pool based on a configuration or preconfiguration of the shared resource pool. The method may include determining the shared resource pool and the dedicated resource pool based on RRC signaling, PC5-RRC signaling, or signaling of a positioning protocol. In other examples, the method includes determining the shared resource pool and the dedicated resource pool based on RRC signaling, PC5-RRC signaling, or signaling of a positioning protocol.

Alternatively, the method may include determining the MAC layer destination ID based on a positioning application ID assigned to the TX UE by preconfiguration or by the UE. In other examples, the method includes determining the MAC layer destination ID based on preconfiguration of the dedicated resource pool, signaling from a network configuring the dedicated resource pool, or a policy control function (PCF).

The method includes, at 1520, deriving a PHY layer destination ID based on the MAC layer destination ID. At 1530, sidelink control information (SCI) is transmitted to the TX UE that includes the request for SL-PRS. In some examples, the method includes transmitting the SCI using resources of a dedicated resource pool to request SL-PRS in resources of the dedicated resource pool or SL-PRS in resources of a shared resource pool. In some examples, the method includes transmitting the SCI using resources of a shared resource pool to request SL-PRS in resources of a dedicated resource pool or SL-PRS in resources of the shared resource pool. The method includes, at 1540, receiving SL-PRS on resources of a dedicated resource pool from the TX UE.

FIG. 16 is a flow diagram outlining an example method 1600 for transmitting SL-PRS based on configuration by a higher layer. The method 1600 may be performed by TX UE 401 and/or 1110 of FIGS. 4 and 11, respectively. A related method is illustrated in FIG. 11. The method includes, at 1610, receiving a PHY layer request from an RX UE for a sidelink positioning reference signal (SL-PRS). The method includes, at 1620, in response to the request, providing an intermediate request based on the request to a higher layer, wherein the intermediate request corresponds to a request for the higher layer to cause the UE to transmit SL-PRS to the RX UE according to the request. The higher layer may be a network device implementing a sidelink positioning protocol (SPP), a new radio (NR) positioning protocol A (NRPPa), or a long term evolution (LTE) positioning protocol (LPP). At 1630, in response to a signal from the higher layer, SL-PRS is transmitted on resources of a dedicated resource pool to the RX UE.

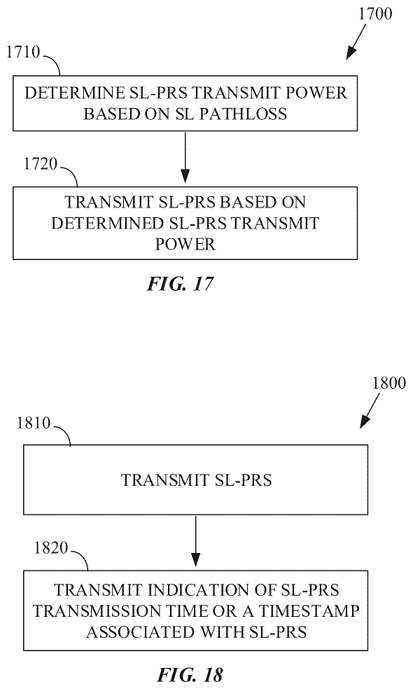

FIG. 17 is a flow diagram outlining an example method 1700 for determining SL-PRS transmit power. The method 1700 may be performed by TX UE 401 and/or 1110 of FIGS. 4 and 11, respectively. The method includes, at 1710, determining a sidelink positioning reference signal SL-PRS transmit power based on an sidelink (SL) pathloss between the UE and a receive (RX) UE or a downlink (DL) pathloss between the UE. At 1720, the method includes transmitting the SL-PRS based on the determined SL-PRS transmit power.

The method may include determining the SL-PRS transmit power based on DL pathloss when the UE is in network coverage or to cause the UE to transmit the SL-PRS using maximum power when the UE is not in network coverage. The method may include determining the SL-PRS transmit power based on SL pathloss, wherein the SL pathloss is determined based on a reference signal receive power (RSRP) measurement received from the RX UE on resources of a shared resource pool that is linked to a dedicated resource pool configured to the UE for SL-PRS. In this example, the method may include using resources of the shared resource pool to initiate a unicast link with the RX UE, where the RSRP measurement is received by way of the unicast link. In some examples, the method includes using PSCCH resources of the shared resource pool to receive the RSRP measurement. The shared resource pool may be preconfigured or configured as linked with the dedicated resource pool.

In some examples, the method includes receiving an RRC layer RSRP report or a PHY layer RSRP report. The method may include determining the SL-PRS pathloss based on a one or more reference signal receive power (RSRP) measurements of PHY layer signals performed by the RX UE.

The method may include receiving RSRP measurement values from the RX UE; and processing the received RSRP measurement values to determine a filtered RSRP value, where the SL-PRS transmit power is based on the filtered RSRP value. The method may include receiving the one or more RSRP measurement values in single stage sidelink control information (SCI). The method may include receiving a filtered RSRP value, wherein the SL-PRS transmit power is based on the filtered RSRP value.

The method may include transmitting single stage SCI to the RX UE that indicates a reference signal transmit power of reference signals transmitted to the RX UE for use by the RX to calculate the SL pathloss.

In other examples, the method includes determining the SL-PRS transmit power based on a transmit power associated with transmitting physical sidelink shared channel (PSSCH) transmissions. The method may include determining a transmit power of an SL-PRS symbol as equivalent to a total transmit power of PSCCH in a dedicated resource pool. The method may include determining a transmit power of an SL-PRS resource element as equivalent to a transmit power per resource element of PSCCH in a dedicated resource pool.

FIG. 18 is a flow diagram outlining an example method 1800 for transmitting SL-PRS using a dedicated resource pool. The method 1800 may be performed by TX UE 401 and/or 1110 of FIGS. 4 and 11, respectively. The method includes, at 1810, transmitting a sidelink positioning reference signal (SL-PRS). At 1820, the method includes transmitting an indication of a transmission time of the SL-PRS or a timestamp associated with the SL-PRS.

In some examples, the transmission time or the timestamp are reported based on a time domain unit (Tc), and wherein a quantization of a Tc is configured or pre-configured for all resource pools or on a per resource pool basis. In some examples, the transmission time or the timestamp is reported an absolute time duration corresponding to a subframe or frame and a quantization of Tc is fixed. In other examples, the transmission time or the timestamp is reported an absolute time duration corresponding to a slot basis and the quantization of Tc is determined based on a subcarrier spacing. The absolute time duration may be 1 millisecond and span a range of −0.5 milliseconds to 0.5 milliseconds.

The method may include reporting the SL-PRS transmission time based on a timestamp associated with an OFDM symbol of start of transmission or measurement of the SL-PRS. The timestamp may indicate a system frame number or a direct frame number of the OFDM symbol of start of transmission or measurement of the SL-PRS.

Above are several flow diagrams outlining example methods and exchanges of messages. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term encode when used with reference to some entity or value of an entity is to be construed broadly as encompassing any manner or technique for generating a data sequence or signal that communicates the entity to another component.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

As used herein, the term derive when used with reference to some entity or value of an entity is to be construed broadly. “Derive” should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. The term derive should be construed to encompass computing or calculating the entity or value of the entity based on other quantities or entities. The term derive should be construed to encompass any manner of deducing or identifying an entity or value of the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

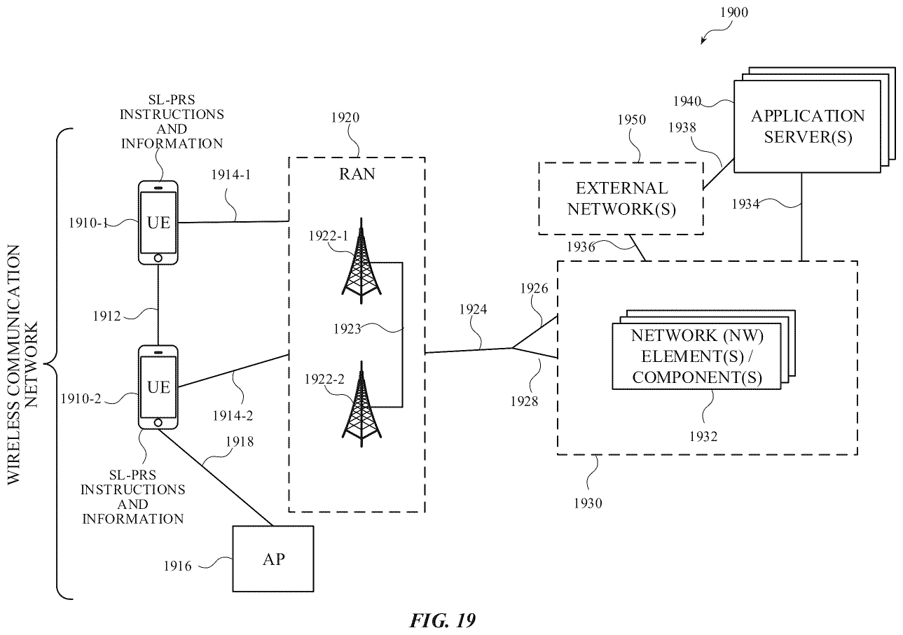

FIG. 19 is an example network 1900 according to one or more implementations described herein. Example network 1900 may include UEs 1910-1, 1910-2, etc. (referred to collectively as “UEs 1910” and individually as “UE 1910”), a radio access network (RAN) 1920, a core network (CN) 1930, application servers 1940, and external networks 1950.

The systems and devices of example network 1900 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 1900 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 1910 may include smartphones (e.g., handheld touchscreen mobile computing devices connectable to one or more wireless communication networks). Additionally, or alternatively, UEs 1910 may include other types of mobile or non-mobile computing devices capable of wireless communications, such as personal data assistants (PDAs), pagers, laptop computers, desktop computers, wireless handsets, watches etc. In some implementations, UEs 1910 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 1910 may use stored SL-PRS instructions and information for performing one or more of the solutions disclosed with reference to FIGS. 1-18 to transmit or receive SL-PRS with another UE 1910 via a wireless channel 1912, each of which may comprise a physical communications interface/layer. The connection may include an M2M connection, MTC connection, D2D connection, SL connection, etc. The connection may involve a PC5 interface. In some implementations, UEs 1910 may be configured to discover one another, negotiate wireless resources between one another, and establish connections between one another, without intervention or communications involving RAN node 1922 or another type of network node. In some implementations, discovery, authentication, resource negotiation, registration, etc., may involve communications with RAN node 1922 or another type of network node.

UEs 1910 may use one or more wireless channels 1912 to communicate with one another. As described herein, UE 1910-1 may communicate with RAN node 1922 to request SL resources. RAN node 1922 may respond to the request by providing UE 1910 with a dynamic grant (DG) or configured grant (CG) regarding SL resources. A DG may involve a grant based on a grant request from UE 1910. A CG may involve a resource grant without a grant request and may be based on a type of service being provided (e.g., services that have strict timing or latency requirements). UE 1910 may perform a clear channel assessment (CCA) procedure based on the DG or CG, select SL resources based on the CCA procedure and the DG or CG; and communicate with another UE 1910 based on the SL resources. The UE 1910 may communicate with RAN node 1922 using a licensed frequency band and communicate with the other UE 1910 using an unlicensed frequency band.

UEs 1910 may communicate and establish a connection with (e.g., be communicatively coupled) with RAN 1920, which may involve one or more wireless channels 1914-1 and 1914-2, each of which may comprise a physical communications interface/layer also called a Uu interface or link.

As described herein, UE 1910 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 1910 may also, or alternatively, connect to access point (AP) 1916 via connection interface 1918, which may include an air interface enabling UE 1910 to communicatively couple with AP 1916. AP 1916 may comprise a wireless local area network (WLAN), WLAN node, WLAN termination point, etc. The connection 1918 may comprise a local wireless connection, such as a connection consistent with any IEEE 702.11 protocol, and AP 1916 may comprise a wireless fidelity (Wi-Fi®) router or other AP. While not explicitly depicted in FIG. 19, AP 1916 may be connected to another network (e.g., the Internet) without connecting to RAN 1920 or CN 1930.

RAN 1920 may include one or more RAN nodes 1922-1 and 1922-2 (referred to collectively as RAN nodes 1922, and individually as RAN node 1922) that enable channels 1914-1 and 1914-2 to be established between UEs 1910 and RAN 1920. RAN nodes 1922 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 1922 may include a roadside unit (RSU), a transmission reception point (TRxP or TRP), and one or more other types of ground stations (e.g., terrestrial access points). In some scenarios, RAN node 1922 may be a dedicated physical device, such as a macrocell base station, and/or a low power (LP) base station for providing femtocells, picocells or the like having smaller coverage areas, smaller user capacity, or higher bandwidth compared to macrocells.

In some implementations, a downlink resource grid may be used for downlink transmissions from any of the RAN nodes 1922 to UEs 1910, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

The RAN nodes 1922 may be configured to communicate with one another via interface 1923. In implementations where the system is an LTE system, interface 1923 may be an X2 interface. In NR systems, interface 1923 may be an Xn interface. The X2 interface may be defined between two or more RAN nodes 1922 (e.g., two or more eNBs/gNBs or a combination thereof) that connect to evolved packet core (EPC) or CN 1930, or between two eNBs connecting to an EPC.

As shown, RAN 1920 may be connected (e.g., communicatively coupled) to CN 1930. CN 1930 may comprise a plurality of network elements 1932, which are configured to offer various data and telecommunications services to customers/subscribers (e.g., users of UEs 1910) who are connected to the CN 1930 via the RAN 1920. In some implementations, CN 1930 may include an evolved packet core (EPC), a 5G CN, and/or one or more additional or alternative types of CNs. Functions provided by the CN 1930 include a policy control function (PCF) and location management function (LMF). The components of the CN 1930 may be implemented in one physical node or separate physical nodes including components to read and execute instructions from a machine-readable or computer-readable medium (e.g., a non-transitory machine-readable storage medium

As shown, CN 1930, application servers 1940, and external networks 1950 may be connected to one another via interfaces 1934, 1936, and 1938, which may include IP network interfaces. The application servers may include servers performing positioning related services, such as V2X servers, for UEs 1910.

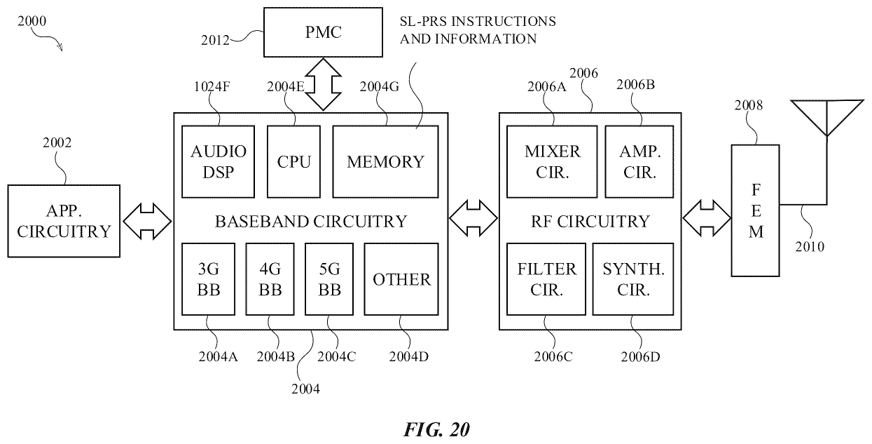

FIG. 20 is a diagram of an example of components of a network device according to one or more implementations described herein. In some implementations, the device 2000 can include application circuitry 2002, baseband circuitry 2004, RF circuitry 2006, front-end module (FEM) circuitry 2008, one or more antennas 2010, and power management circuitry (PMC) 2012 coupled together at least as shown. The components of the illustrated device 2000 can be included in a UE or a RAN node. In some implementations, the device 2000 can include fewer elements (e.g., a RAN node may not utilize application circuitry 2002, and instead include a processor/controller to process IP data received from a CN or an Evolved Packet Core (EPC)). In some implementations, the device 2000 can include additional elements such as, for example, memory/storage, display, camera, sensor (including one or more temperature sensors, such as a single temperature sensor, a plurality of temperature sensors at different locations in device 2000, etc.), or input/output (I/O) interface. In other implementations, the components described below can be included in more than one device (e.g., said circuitries can be separately included in more than one device for Cloud-RAN (C-RAN) implementations).

The application circuitry 2002 can include one or more application processors. For example, the application circuitry 2002 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 2000. In some implementations, processors of application circuitry 2002 can process IP data packets received from an EPC.

The baseband circuitry 2004 can include circuitry such as, but not limited to, one or more single-core or multi-core processors. The baseband circuitry 2004 can include one or more baseband processors or control logic to process baseband signals received from a receive signal path of the RF circuitry 2006 and to generate baseband signals for a transmit signal path of the RF circuitry 2006. Baseband circuitry 2004 can interface with the application circuitry 2002 for generation and processing of the baseband signals and for controlling operations of the RF circuitry 2006. For example, in some implementations, the baseband circuitry 2004 can include a 3G baseband processor 2004A, a 4G baseband processor 2004B, a 5G baseband processor 2004C, or other baseband processor(s) 2004D for other existing generations, generations in development or to be developed in the future (e.g., 5G, 6G, etc.).

The baseband circuitry 2004 (e.g., one or more of baseband processors 2004A-D) can handle various radio control functions that enable communication with one or more radio networks via the RF circuitry 2006. In other implementations, some or all of the functionality of baseband processors 2004A-D can be included in modules stored in the memory 2004G and executed via a Central Processing Unit (CPU) 2004E. In some implementations, the baseband circuitry 2004 can include one or more audio digital signal processor(s) (DSP) 2004F.

In some implementations, memory 2004G may receive and/or store SL-PRS instructions and information that cause the device 2000 to act as a TX UE and/or RX UE in transmitting or receiving SL-PRS as disclosed with reference to FIGS. 1-18.

RF circuitry 2006 can enable communication with wireless networks using modulated electromagnetic radiation through a non-solid medium. In various implementations, the RF circuitry 2006 can include switches, filters, amplifiers, etc. to facilitate the communication with the wireless network. RF circuitry 2006 can include a receive signal path which can include circuitry to down-convert RF signals received from the FEM circuitry 2008 and provide baseband signals to the baseband circuitry 2004. RF circuitry 2006 can also include a transmit signal path which can include circuitry to up-convert baseband signals provided by the baseband circuitry 2004 and provide RF output signals to the FEM circuitry 2008 for transmission.

In some implementations, the receive signal path of the RF circuitry 2006 can include mixer circuitry 2006A, amplifier circuitry 2006B and filter circuitry 2006C. In some implementations, the transmit signal path of the RF circuitry 2006 can include filter circuitry 2006C and mixer circuitry 2006A. RF circuitry 2006 can also include synthesizer circuitry 2006D for synthesizing a frequency for use by the mixer circuitry 2006A of the receive signal path and the transmit signal path.

Examples herein can include subject matter such as a method, means for performing acts or blocks of the method, at least one machine-readable medium including executable instructions that, when performed by a machine or circuitry (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.
Example 1 is a user equipment (UE), including a memory and a baseband processor. The baseband processor is configured to, when executing instructions stored in the memory, cause the UE to select a sidelink positioning reference signal (SL-PRS) resource from a dedicated resource pool, wherein the dedicated resource pool includes candidate physical sidelink control channel (PSCCH) resources configured to carry single stage sidelink control information (SCI) and candidate SL-PRS resources, wherein the dedicated resource pool does not include candidate resources for physical sidelink shared channel (PSSCH) transmission; and transmit the SL-PRS in the selected SL-PRS resource.
Example 2 includes the subject matter of example 1, including or omitting optional elements, wherein the baseband processor is configured to select periodic SL-PRS resources that occur in the same frequency domain resources in a same slot of each SL-PRS resource period during a reservation period.
Example 3 includes the subject matter of example 1, including or omitting optional elements, wherein the baseband processor is configured to select aperiodic SL-PRS resources.
Example 4 includes the subject matter of example 1, including or omitting optional elements, wherein each candidate SL-PRS resource is indicated by a slot index and a sub-channel index or a slot index and an SL-PRS resource index.
Example 5 includes the subject matter of example 4, including or omitting optional elements, wherein PSCCH resources in slot in the dedicated resource pool are indexed in terms of frequency location; and SL-PRS resources in a slot in the dedicated resource pool are indexed in order of frequency in an SL-PRS resource first, and by SL-PRS resource second; or in order of symbol in an SL-PRS resource first, frequency in an SL-RS resource second, and SL-PRS resource third; or in order of symbol in an SL-PRS resource first, SL-PRS resource second, and frequency third.
Example 6 includes the subject matter of example 4, including or omitting optional elements, wherein each PSCCH resource is mapped to one SL-PRS resource, where a mapped SL-PRS resource index is the same as a PSCCH resource index or the mapped SL-PRS resource index is different from the PSCCH resource index.
Example 7 includes the subject matter of example 4, including or omitting optional elements, wherein each PSCCH is mapped to a set of SL-PRS resources and wherein the baseband processor is configured to transmit an indication of a selected one of the set of SL-PRS resource in single stage SCI carried by the PSCCH resource.
Example 8 includes the subject matter of example 7, including or omitting optional elements, wherein the set of SL-PRS resources have consecutive SL-PRS resource indices.
Example 9 includes the subject matter of example 7, including or omitting optional elements, wherein the set of SL-PRS resources have interleaved SL-PRS resource indices.
Example 10 includes the subject matter of example 7, including or omitting optional elements, wherein the baseband processor is configured to select an SL-PRS resource from amongst the set of SL-PRS resources based on one or more of a priority associated with the SL-PRS, a resource reservation periodicity, a SL channel busy ratio, or a SL channel occupancy ratio.
Example 11 includes the subject matter of example 1, including or omitting optional elements, wherein the baseband processor is configured to cause the UE to select the SL-PRS resource from the dedicated resource pool by measuring a reference signal receive power (RSRP) of single stage SCI in candidate PSCCH of the dedicated resource pool; decoding the single stage SCI to determine a resource reservation period and priority of respective SL-PRS associated with respective SCI; and excluding, from the candidate resource pool, candidate resources associated with single stage SCI having a higher RSRP than a threshold.
Example 12 includes the subject matter of example 11, including or omitting optional elements, wherein the threshold is selected based on the priority indicated in the single stage SCI or a priority of the SL-PRS.
Example 13 includes the subject matter of example 1, including or omitting optional elements, wherein the baseband processor is configured to, at a pre-emption time interval prior to the selected SL-PRS resource, decode single stage SCI to determine if the selected SL-PRS resource is reserved for a higher priority SL-PRS; and refrain from transmitting the SL-PRS when the selected SL-PRS resource is reserved for a higher priority SL-PRS.
Example 14 includes the subject matter of example 13, including or omitting optional elements, wherein the baseband processor is configured to decode single stage SCI in a same sub-channel as the selected SL-PRS resource and compare a priority of SL-PRS associated with the single stage SCI with the priority of the SL-PRS to be transmitted.
Example 15 includes the subject matter of example 13, including or omitting optional elements, wherein the baseband processor is configured to decode single stage SCI in all sub-channels of the dedicated resource pool and compare a priority of respective SL-PRS associated with the single stage SCI with the priority of the SL-PRS to be transmitted.
Example 16 includes the subject matter of example 1, including or omitting optional elements, wherein the single stage SCI includes an indication of one or more of a source ID for the UE, a destination ID for a receive (RX) UE, a priority of an associated SL-PRS, a resource reservation period, an aperiodic resource reservation, an SL-PRS resource indicator for a first transmission, an SL-PRS resource indicator for a re-transmission of the SL-PRS, a PHY layer reference signal receive power (RSRP) report, or a an RRC layer RSRP report.
Example 17 includes the subject matter of example 1, including or omitting optional elements, wherein the baseband processor is configured to map an SL-PRS sequence to resource elements in a slot on an antenna port based on a configured or preconfigured comb size and a comb offset, wherein the comb offset is defined relative to a reference point.
Example 18 includes the subject matter of example 17, including or omitting optional elements, wherein the antenna port is different from an antenna port used to transmit PSCCH.
Example 19 includes the subject matter of example 17, including or omitting optional elements, wherein the reference point is a common reference point A associated with Uu link communication, a lowest subcarrier in a lowest physical resource block of the dedicated resource pool or a sidelink bandwidth part, or a configured or predefined offset from a lowest subcarrier in a lowest physical resource block of the dedicate resource pool or a sidelink bandwidth part.
Example 20 is a user equipment (UE), including a memory and a baseband processor. The baseband processor is configured to, when executing instructions stored in the memory, cause the UE to select a sidelink positioning reference signal (SL-PRS) resource based on a resource allocation received from a network; and transmit the SL-PRS in the selected SL-PRS resource.
Example 21 includes the subject matter of example 20, including or omitting optional elements, wherein the resource allocation indicates one or more of a shared resource pool index, dedicated resource pool index, a time gap, an SCI format 1-A/time resource assignment, a configuration index, a sub-channel index of a first SL-PRS transmission, a sub-channel index of an SL-PRS re-transmission, an SL-PRS resource index of a first SL-PRS transmission, an SL-PRS resource index of an SL-PRS re-transmission.
Example 22 includes the subject matter of example 21, including or omitting optional elements, wherein the resource allocation includes downlink control information (DCI) that identifies the UE based on an SL-PRS radio network temporary identifier (RNTI) or an SL-PRS configured scheduled RNTI that is assigned to the UE based on the dedicated resource pool.
Example 23 includes the subject matter of example 21, including or omitting optional elements, wherein the resource allocation includes a configured grant that indicates one or more of an SL-PRS configured grant configuration index, an SL-PRS configured grant period, a time resource of the configured grant, a time offset of the configured grant, a time reference system frame number of the SL-PRS, a dedicated resource pool identifier.
Example 24 is a user equipment (UE), including a memory and a baseband processor. The baseband processor is configured to, when executing instructions stored in the memory, cause the UE to exchange unicast messages with a second UE using resources of a shared resource pool; and transmit or receive sidelink positioning reference signals (SL-PRS) using SL-PRS resources of a dedicated resource pool, wherein the dedicated resource pool is linked to the shared resource pool by configuration or pre-configuration.
Example 25 includes the subject matter of example 24, including or omitting optional elements, wherein the baseband processor is configured to cause the UE to establish a unicast link with the second UE using resources of the shared resource pool; receive a destination identifier (ID) or a source ID from the second UE using resources of the shared resource pool; and transmitting or receiving SL-PRS based on the received destination ID or source ID.
Example 26 includes the subject matter of example 25, including or omitting optional elements, wherein the baseband processor is configured to cause the UE to transmit or receive an UE capability information or an open loop power configuration using the unicast link.
Example 27 includes the subject matter of example 24, including or omitting optional elements, wherein the baseband processor is configured to cause the UE to transmit SL data using resources of the dedicated resource pool, a different shared resource pool that is linked to the dedicated resource pool, or a different dedicated resource pool.
Example 28 is a user equipment (UE), including a memory and a baseband processor. The baseband processor is configured to, when executing instructions stored in the memory, cause the UE to determine a MAC layer destination ID of a transmit (TX) UE; derive a PHY layer destination ID based on the MAC layer destination ID; transmit a PHY layer request to the TX UE for a sidelink positioning reference signal (SL-PRS); and receive SL-PRS on resources of a dedicated resource pool from the TX UE.
Example 29 includes the subject matter of example 28, including or omitting optional elements, wherein the baseband processor is configured to determine the MAC destination ID by establishing a unicast link with TX UE using a shared resource pool that is linked to the dedicated resource pool, wherein the UE is configured or preconfigured with the shared resource pool or the dedicated resource pool; and determining the MAC layer destination ID based on the unicast link.
Example 30 includes the subject matter of example 29, including or omitting optional elements, wherein the shared resource pool is linked to more than one dedicated resource pool.
Example 31 includes the subject matter of example 29, including or omitting optional elements, wherein the dedicated resource pool is linked to more than one shared resource pool.
Example 32 includes the subject matter of example 29, including or omitting optional elements, wherein the baseband processor is configured to determine a MAC layer source ID based on either the dedicated resource pool or the shared resource pool.
Example 33 includes the subject matter of example 29, including or omitting optional elements, wherein the shared resource pool and the dedicated resource pool are identified by a resource pool identifier (ID), a resource pool configuration indicated in an information element, or by resource pool time and frequency resources.
Example 34 includes the subject matter of example 29, including or omitting optional elements, wherein the baseband processor is configured to determine the shared resource pool based on a configuration or preconfiguration of the dedicated resource pool.
Example 35 includes the subject matter of example 29, including or omitting optional elements, wherein the baseband processor is configured to determine the dedicated resource pool based on a configuration or preconfiguration of the shared resource pool.
Example 36 includes the subject matter of example 29, including or omitting optional elements, wherein the baseband processor is configured to determine the shared resource pool and the dedicated resource pool based on RRC signaling, PC5-RRC signaling, or signaling of a positioning protocol.
Example 37 includes the subject matter of example 28, including or omitting optional elements, wherein the baseband processor is configured to determine the MAC layer destination ID based on a positioning application ID assigned to the TX UE by preconfiguration or by the UE.
Example 38 includes the subject matter of example 28, including or omitting optional elements, wherein the baseband processor is configured to determine the MAC layer destination ID based on preconfiguration of the dedicated resource pool, signaling from a network configuring the dedicated resource pool, or a policy control function (PCF).
Example 39 includes the subject matter of example 28, including or omitting optional elements, wherein the baseband processor is configured to cause the UE to transmit sidelink control information (SCI) that includes the request for SL-PRS.
Example 40 includes the subject matter of example 39, including or omitting optional elements, wherein the baseband processor is configured to cause the UE to transmit the SCI using resources of a dedicated resource pool to request SL-PRS in resources of the dedicated resource pool or SL-PRS in resources of a shared resource pool.
Example 41 includes the subject matter of example 39, including or omitting optional elements, wherein the baseband processor is configured to cause the UE to transmit the SCI using resources of a shared resource pool to request SL-PRS in resources of a dedicated resource pool or SL-PRS in resources of the shared resource pool.
Example 42 is a user equipment (UE), including a memory and a baseband processor. The baseband processor is configured to, when executing instructions stored in the memory, cause the UE to receive a PHY layer request from an RX UE for a sidelink positioning reference signal (SL-PRS); in response to the request, provide an intermediate request based on the request to a higher layer, wherein the intermediate request corresponds to a request for the higher layer to cause the UE to transmit SL-PRS to the RX UE according to the request; and in response to a signal from the higher layer, transmit SL-PRS on resources of a dedicated resource pool to the RX UE.
Example 43 includes the subject matter of example 42, including or omitting optional elements, wherein the higher layer includes a network device implementing a sidelink positioning protocol (SPP), a new radio (NR) positioning protocol A (NRPPa), or a long term evolution (LTE) positioning protocol (LPP).
Example 44 is a user equipment (UE), including a memory and a baseband processor. The baseband processor is configured to, when executing instructions stored in the memory, cause the UE to determine a sidelink positioning reference signal SL-PRS transmit power based on an sidelink (SL) pathloss between the UE and a receive (RX) UE or a downlink (DL) pathloss between the UE; and transmitting the SL-PRS based on the determined SL-PRS transmit power.
Example 45 includes the subject matter of example 44, including or omitting optional elements, wherein the baseband processor is configured to determine the SL-PRS transmit power based on DL pathloss when the UE is in network coverage or to cause the UE to transmit the SL-PRS using maximum power when the UE is not in network coverage.
Example 46 includes the subject matter of example 44, including or omitting optional elements, wherein the baseband processor is configured to determine the SL-PRS transmit power based on SL pathloss, wherein the SL pathloss is determined based on a reference signal receive power (RSRP) measurement received from the RX UE on resources of a shared resource pool that is linked to a dedicated resource pool configured to the UE for SL-PRS.
Example 47 includes the subject matter of example 46, including or omitting optional elements, wherein the baseband processor is configured to use resources of the shared resource pool to initiate a unicast link with the RX UE and wherein the RSRP measurement is received by way of the unicast link.
Example 48 includes the subject matter of example 46, including or omitting optional elements, wherein the baseband processor is configured to use PSCCH resources of the shared resource pool to receive the RSRP measurement.
Example 49 includes the subject matter of example 46, including or omitting optional elements wherein the shared resource pool is preconfigured or configured as linked with the dedicated resource pool.
Example 50 includes the subject matter of example 44, including or omitting optional elements, wherein the baseband processor is configured to cause the UE to receive an RRC layer RSRP report or a PHY layer RSRP report.
Example 51 includes the subject matter of example 44, including or omitting optional elements, wherein the baseband processor is configured to determine the SL pathloss based on a one or more reference signal receive power (RSRP) measurements of PHY layer signals performed by the RX UE.
Example 52 includes the subject matter of example 44, including or omitting optional elements, wherein the baseband processor is configured to cause the UE to receive RSRP measurement values from the RX UE; and process the received RSRP measurement values to determine a filtered RSRP value, wherein the SL-PRS transmit power is based on the filtered RSRP value.
Example 53 includes the subject matter of example 52, including or omitting optional elements, wherein the baseband processor is configured to cause the UE to receive the one or more RSRP measurement values in single stage sidelink control information (SCI).
Example 54 includes the subject matter of example 44, including or omitting optional elements, wherein the baseband processor is configured to cause the UE to receive a filtered RSRP value, wherein the SL-PRS transmit power is based on the filtered RSRP value.
Example 55 includes the subject matter of example 54, including or omitting optional elements, wherein the baseband processor is configured to cause the UE to transmit a single stage SCI to the RX UE that indicates a reference signal transmit power of reference signals transmitted to the RX UE for use by the RX to calculate the SL pathloss.
Example 56 includes the subject matter of example 44, including or omitting optional elements, wherein the baseband processor is configured to determine the SL-PRS transmit power based on a transmit power associated with transmitting physical sidelink shared channel (PSSCH) transmissions.
Example 57 includes the subject matter of example 44, including or omitting optional elements, wherein the baseband processor is configured to determine a transmit power of an SL-PRS symbol as equivalent to a total transmit power of PSCCH in a dedicated resource pool.
Example 58 includes the subject matter of example 44, including or omitting optional elements, wherein the baseband processor is configured to determine a transmit power of an SL-PRS resource element as equivalent to a transmit power per resource element of PSCCH in a dedicated resource pool.
Example 59 is a user equipment (UE), including a memory and a baseband processor. The baseband processor is configured to, when executing instructions stored in the memory, cause the UE to transmit a sidelink positioning reference signal (SL-PRS); and transmit an indication of a transmission time of the SL-PRS or a timestamp associated with the SL-PRS.
Example 60 includes the subject matter of example 59, including or omitting optional elements, wherein the transmission time or the timestamp are reported based on a time domain unit (Tc), and wherein a quantization of a Tc is configured or pre-configured for all resource pools or on a per resource pool basis.
Example 61 includes the subject matter of example 60, including or omitting optional elements, the transmission time or the timestamp is reported an absolute time duration corresponding to a subframe or frame and a quantization of Tc is fixed, or the transmission time or the timestamp is reported an absolute time duration corresponding to a slot basis and the quantization of Tc is determined based on a subcarrier spacing.
Example 62 includes the subject matter of example 61, including or omitting optional elements, wherein the absolute time duration is 1 millisecond and spans a range of −0.5 milliseconds to 0.5 milliseconds.
Example 63 includes the subject matter of example 59, including or omitting optional elements, wherein the baseband processor is configured to report the SL-PRS transmission time based on a timestamp associated with an OFDM symbol of start of transmission or measurement of the SL-PRS.
Example 64 includes the subject matter of example 63, including or omitting optional elements, wherein the timestamp indicates a system frame number or a direct frame number of the OFDM symbol of start of transmission or measurement of the SL-PRS.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases. In some embodiments, the methods illustrated above may be implemented in a computer readable medium using instructions stored in a memory. Many other embodiments and variations are possible within the scope of the claimed disclosure.

The term “couple” is used throughout the specification. The term may cover connections, communications, or signal paths that enable a functional relationship consistent with the description of the present disclosure. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-31. (canceled)

32. A user equipment (UE), comprising:
a baseband processor configured to, when executing instructions stored in a memory, cause the UE to select a sidelink positioning reference signal (SL-PRS) resource from a dedicated resource pool, wherein the dedicated resource pool includes candidate physical sidelink control channel (PSCCH) resources configured to carry single stage sidelink control information (SCI) and candidate SL-PRS resources, wherein the dedicated resource pool does not include candidate resources for physical sidelink shared channel (PSSCH) transmission; and
radio frequency circuitry coupled to the baseband processor, the radio frequency circuitry configured to transmit the SL-PRS in the selected SL-PRS resource.

33. The UE of claim 32 wherein each candidate SL-PRS resource is indicated by a slot index, a sub-channel index, or an SL-PRS resource index.

34. The UE of claim 32, wherein
PSCCH resources in slot in the dedicated resource pool are indexed in terms of frequency location; and
SL-PRS resources in a slot in the dedicated resource pool are indexed in order of frequency in an SL-PRS resource first, and by SL-PRS resource second; or in order of symbol in an SL-PRS resource first, frequency in an SL-RS resource second, and SL-PRS resource third; or in order of symbol in an SL-PRS resource first, SL-PRS resource second, and frequency third.

35. The UE of claim 32, wherein each PSCCH resource is mapped to one SL-PRS resource, where a mapped SL-PRS resource index is the same as a PSCCH resource index.

36. The UE of claim 32, wherein each PSCCH is mapped to a set of SL-PRS resources and wherein the baseband processor is configured to transmit an indication of a selected one of the set of SL-PRS resource in single stage SCI carried by the PSCCH resource.

37. The UE of claim 32, wherein the baseband processor is configured to cause the UE to select the SL-PRS resource from the dedicated resource pool by
measuring a reference signal receive power (RSRP) of single stage SCI in candidate PSCCH of the dedicated resource pool;
decoding the single stage SCI to determine a resource reservation period and priority of respective SL-PRS associated with respective SCI; and
excluding, from the candidate resource pool, candidate resources associated with single stage SCI having a higher RSRP than a threshold.

38. The UE of claim 37, wherein the threshold is selected based on the priority indicated in the single stage SCI or a priority of the SL-PRS.

39. The UE of claim 32, wherein the single stage SCI includes an indication of one or more of a source ID for the UE, a destination ID for a receive (RX) UE, a priority of an associated SL-PRS, a resource reservation period, an aperiodic resource reservation, an SL-PRS resource indicator for a first transmission, an SL-PRS resource indicator for a re-transmission of the SL-PRS, a PHY layer reference signal receive power (RSRP) report, or a an RRC layer RSRP report.

40. A baseband processor configured to perform operations comprising:
selecting a sidelink positioning reference signal (SL-PRS) resource based on a resource allocation received from a network; and
causing transmission of the SL-PRS in the selected SL-PRS resource.

41. The baseband processor of claim 40, wherein the resource allocation comprises downlink control information (DCI) that identifies a UE based on an SL-PRS radio network temporary identifier (RNTI) or an SL-PRS configured scheduled RNTI that is assigned to the UE based on a dedicated resource pool.

42. The baseband processor of claim 40, wherein the resource allocation indicates one or more of a shared resource pool index, dedicated resource pool index, a time gap, an SCI format 1-A/time resource assignment, a configuration index, a sub-channel index of a first SL-PRS transmission, a sub-channel index of an SL-PRS re-transmission, an SL-PRS resource index of a first SL-PRS transmission, an SL-PRS resource index of an SL-PRS re-transmission.

43. The baseband processor of claim 40, wherein the resource allocation comprises a configured grant that indicates one or more of an SL-PRS configured grant configuration index, an SL-PRS configured grant period, a time resource of the configured grant, a time offset of the configured grant, a time reference system frame number of the SL-PRS, a dedicated resource pool identifier.

44. A user equipment (UE) comprising a memory and a baseband processor configured to, when executing instructions stored in the memory,
determine a sidelink positioning reference signal (SL-PRS) transmit power based on an sidelink (SL) pathloss between the UE and a receive (RX) UE or a downlink (DL) pathloss between the UE; and
transmitting the SL-PRS based on the determined SL-PRS transmit power.

45. The UE of claim 44, wherein the baseband processor is configured to determine the SL-PRS transmit power based on DL pathloss when the UE is in network coverage or to cause the UE to transmit the SL-PRS using maximum power when the UE is not in network coverage.

46. The UE of claim 44, wherein the baseband processor is configured to determine the SL-PRS transmit power based on SL pathloss, wherein the SL pathloss is determined based on a reference signal receive power (RSRP) measurement received from the RX UE on resources of a shared resource pool that is linked to a dedicated resource pool configured to the UE for SL-PRS.

47. The UE of claim 46, wherein the baseband processor is configured to use resources of the shared resource pool to initiate a unicast link with the RX UE and wherein the RSRP measurement is received by way of the unicast link.

48. The UE of claim 46, wherein the baseband processor is configured to use PSCCH resources of the shared resource pool to receive the RSRP measurement.

49. The UE of claim 46, wherein the shared resource pool is preconfigured or configured as linked with the dedicated resource pool.

50. The UE of claim 46, wherein the baseband processor is configured to cause the UE to receive an RRC layer RSRP report or a PHY layer RSRP report.

51. The UE of claim 44, wherein the baseband processor is configured to determine the SL-PRS transmit power based on SL pathloss, wherein the SL pathloss is determined based on a one or more reference signal receive power (RSRP) measurements of PHY layer signals performed by the RX UE.
